(19) United States
(12) Patent Application Publication
(10) Pub. No.: US 2025/0370403 A1
(43) Pub. Date: Dec. 4, 2025

(54) IMAGE FORMING APPARATUS

(71) Applicant: CANON KABUSHIKI KAISHA, Tokyo (JP)

(72) Inventor: RYO ABE, Chiba (JP)

(21) Appl. No.: 19/200,048

(22) Filed: May 6, 2025

(30) Foreign Application Priority Data
May 31, 2024 (JP) 2024-088846

(51) Int. Cl. G03G 21/16; G03G 15/04

(52) U.S. Cl. CPC G03G 21/1666; G03G 15/04054; G03G 15/04063; G03G 15/0409; G03G 2215/0409; G03G 2215/0412; G03G 2221/0089

(57) ABSTRACT

An image forming apparatus includes a photoconductor, an exposure head that includes a substrate on which a plurality of light emitting elements is mounted in a longitudinal direction that is an axial direction of the photoconductor, and a lens array including a plurality of lenses that condenses light emitted from the light emitting elements onto the photoconductor, and exposes the photoconductor, a longitudinal-shaped cleaning rod that is inserted from outside of the image forming apparatus and cleans emission surfaces of the lenses by rubbing the lenses in the longitudinal direction, and a guide member that guides the cleaning rod inserted from the outside of the image forming apparatus, in which the cleaning rod includes a cleaning member that abuts on the emission surfaces of the lenses and cleans off attached matter attached to the emission surfaces of the lenses, a first portion whose cross-sectional shape in a direction orthogonal to the longitudinal direction is a first cross-sectional shape, and a second portion that is provided at a position different from a position of the first portion in the longitudinal direction and has a second cross-sectional shape different from the first cross-sectional shape of the first portion.

### BACKGROUND OF THE INVENTION

### Field of the Invention

The present invention relates to an image forming apparatus including an exposure head that exposes a photoconductor.

### Description of the Related Art

In an electrophotographic image forming apparatus such as a printer or a copying machine, a fixed exposure head is one of units for exposing a photoconductor. The fixed exposure head has a plurality of light emitting elements such as LEDs is arranged in an axial direction of the photoconductor, and collectively exposes the photoconductor in the axial direction.

The fixed exposure head includes a lens array in which a plurality of lenses is arranged in the axial direction to face a light emitting element in order to form an image of a light flux emitted from the light emitting element on the photoconductor. Since this lens array has an extremely short focal length, it is necessary to dispose the exposure head close to the photoconductor. However, toner may be floating in the vicinity of the photoconductor. When such floating toner adheres to an emission surface of the lens array, the quantity of light applied to the photoconductor becomes nonuniform, and an image defect such as density unevenness may occur.

Therefore, in an image forming apparatus including a fixed exposure head, a configuration including a cleaning member cleaning an emission surface of a lens array in the fixed exposure head has been disclosed. In Japanese Patent Application Laid-Open No. 2008-173811, by engaging a hook portion provided in a cleaning member with a guide groove provided in an exposure head, the cleaning member abuts on an emission surface of a lens and can clean the emission surface.

However, in the above-described conventional technique, in a case where an operator roughly operates the cleaning member, the cleaning member may be separated from the emission surface of the lens by the operation force. When the cleaning member is separated from the emission surface of the lens, it is difficult to reliably clean off toner attached to the emission surface of the lens.

### SUMMARY OF THE INVENTION

A typical configuration of the present invention includes a photoconductor; an exposure head that includes a substrate on which a plurality of light emitting elements is mounted in a longitudinal direction that is an axial direction of the photoconductor, and a lens array including a plurality of lenses that condenses light emitted from the light emitting elements onto the photoconductor, and exposes the photoconductor; a longitudinal-shaped cleaning rod that is inserted from outside of the image forming apparatus and cleans emission surfaces of the lenses by rubbing the lenses in the longitudinal direction; and a guide member that guides the cleaning rod inserted from the outside of the image forming apparatus, in which the cleaning rod includes a cleaning member that abuts on the emission surfaces of the lenses and cleans off attached matter attached to the emission surfaces of the lenses, a first portion whose cross-sectional shape in a direction orthogonal to the longitudinal direction is a first cross-sectional shape, and a second portion that is provided at a position different from a position of the first portion in the longitudinal direction and has a second cross-sectional shape different from the first cross-sectional shape of the first portion.

Further features of the present invention will become apparent from the following description of exemplary embodiments with reference to the attached drawings.

### BRIEF DESCRIPTION OF THE DRAWINGS

FIG. 1 is a perspective view of an image forming apparatus.

FIG. 2 is a schematic cross-sectional view of the image forming apparatus.

FIG. 3 is a schematic cross-sectional view of the image forming apparatus.

FIGS. 4A and 4B are perspective views illustrating a configuration of a drum unit and a vicinity of a development unit.

FIG. 5A is a perspective view illustrating a cartridge tray, an inner door in a closed state, and an exposure head at an exposure position, and FIG. 5B is a perspective view illustrating the cartridge tray, the inner door in an open state, and the exposure head at a retraction position.

FIG. 6 is a schematic cross-sectional view of the exposure head.

FIG. 7 is a perspective view of an exposure head as viewed from above.

FIG. 8 is a perspective view of an exposure head as viewed from below.

FIGS. 9A, 9B, and 9C are views illustrating a substrate in the exposure head, and FIGS. 9D and 9E are views illustrating a lens array.

FIG. 10 is a cross-sectional perspective view of the exposure head.

FIG. 11 is a cross-sectional view illustrating a sealing configuration of a front pilot hole portion of the exposure head.

FIG. 12 is a cross-sectional view illustrating a sealing configuration of a rear pilot hole portion of the exposure head.

FIG. 13 is a perspective view of the cartridge tray as viewed from below.

FIG. 14 is a cross-sectional view taken along line X-X in FIG. 13.

FIG. 15 is a cross-sectional view taken along line A-A in FIG. 2.

FIG. 16 is a perspective view of a duct unit.

FIG. 17A is a view illustrating a sheet of the exposure head according to the first embodiment and a length of an opening in a longitudinal direction, and FIG. 17B is a top view of the exposure head according to the first embodiment.

FIGS. 18A and 18B are cross-sectional views of an optical print head according to the first embodiment in a lateral direction.

FIG. 19 is a cross-sectional view of the optical print head according to the first embodiment in a longitudinal direction.

FIGS. 20A and 20B are perspective views of a casing support member according to the first embodiment.

FIG. 21 is a perspective view of the exposure head, a lifting/lowering duct, and a duct unit according to the first embodiment.

FIG. 22A is a perspective view viewed from a front surface cut in a direction orthogonal to an axial direction of a photoconductive drum at a center position of a positioning pin, and FIG. 22B is a perspective view viewed from a rear surface cut in the direction orthogonal to the axial direction of the photoconductive drum at the center position of the positioning pin.

FIG. 23 is a perspective view of a positioning member after attachment.

FIG. 24 is a perspective view of the positioning member before attachment.

FIG. 25 is a perspective view illustrating a shape of the positioning member.

FIGS. 26A, 26B, and 26C are diagrams illustrating a configuration of a cleaning rod according to the first embodiment.

FIGS. 27A and 27B are views illustrating a configuration of the cleaning rod according to the first embodiment.

FIGS. 28A, 28B, and 28C are diagrams illustrating a guide configuration of the cleaning rod according to the first embodiment.

FIGS. 29A and 29B are diagrams illustrating a configuration of a first guide member according to the first embodiment.

FIGS. 30A and 30B are diagrams illustrating a configuration of a second guide member according to the first embodiment.

FIGS. 31A, 31B, and 31C are views illustrating a configuration of the cleaning member according to the first embodiment.

FIGS. 32A and 32B are views illustrating a shape of a notch portion according to the first embodiment.

FIGS. 33A and 33B are views illustrating effects of the notch portion according to the first embodiment.

FIGS. 34A and 34B are diagrams illustrating a configuration of a stopper according to the first embodiment.

FIGS. 35A and 35B are diagrams illustrating a length relationship of each portion according to the first embodiment.

FIG. 36 is a cross-sectional view of the rear pilot hole portion.

FIGS. 37A and 37B are diagrams illustrating foreign matter entry checking results based on actual measurement.

### DESCRIPTION OF THE EMBODIMENTS

Hereinafter, embodiments of the present invention will be described with reference to the drawings. Note that dimensions, materials, shapes, relative arrangements, and the like of the constitutions described below are merely examples, and the scope of the present invention is not intended to be limited thereto.

### First Embodiment

### (Image Forming Apparatus)

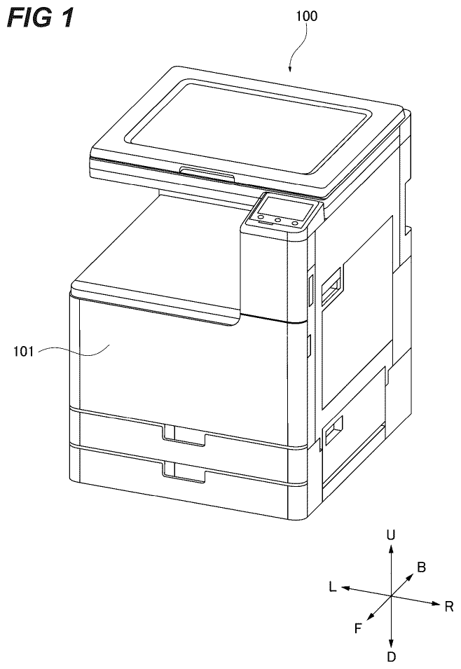

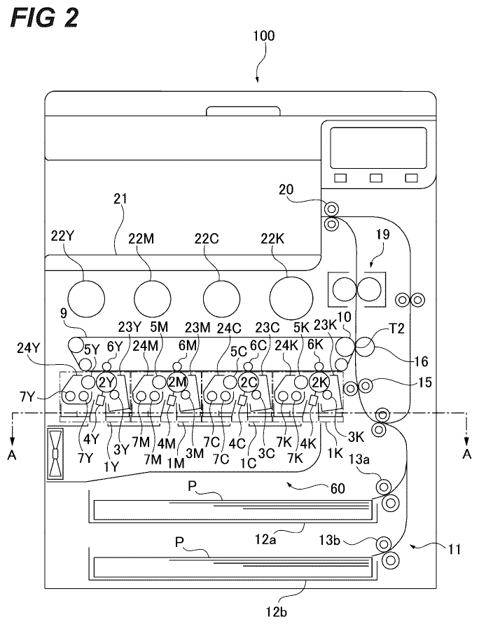

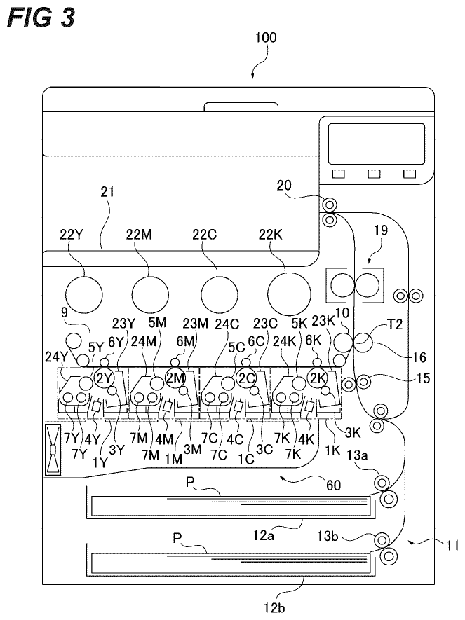

First, a schematic configuration of an image forming apparatus 100 will be described with reference to FIGS. 1, 2, and 3. FIG. 1 is a perspective view of the image forming apparatus 100. FIGS. 2 and 3 are schematic cross-sectional views of the image forming apparatus in FIG. 1. The image forming apparatus 100 illustrated in FIGS. 1 to 3 is a copying machine including a reading device, but an embodiment may be another image forming apparatus such as a printer not including a reading device. An embodiment is not limited to a color image forming apparatus including a plurality of photoconductive drums 2 as illustrated in FIGS. 2 and 3, and may be a color image forming apparatus including one photoconductive drum 2 or an image forming apparatus that forms a monochrome image.

The image forming apparatus 100 illustrated in FIGS. 2 and 3 includes four image forming portions 1Y, 1M, 1C, and 1K (hereinafter, also collectively and simply referred to as “image forming portion 1”) that form toner images of respective colors of yellow, magenta, cyan, and black.

Each of the image forming portions 1Y, 1M, 1C, and 1K includes photoconductive drums 2Y, 2M, 2C, and 2K (hereinafter, also collectively and simply referred to as “photoconductive drum 2”), which are examples of photoconductors (image bearing members). These photoconductive drums are arranged apart from each other. The photoconductive drum may be a photoconductive belt.

The image forming portions 1Y, 1M, 1C, and 1K include charging rollers 3Y, 3M, 3C, and 3K (hereinafter, also collectively and simply referred to as “charging roller 3”) as charging portions that respectively charge the photoconductive drums 2Y, 2M, 2C, and 2K.

The image forming portions 1Y, 1M, 1C, and 1K include exposure heads 4Y, 4M, 4C, and 4K (hereinafter, also collectively and simply referred to as “exposure head 4”) as exposure devices (exposure portions) that expose the photoconductive drums 2Y, 2M, 2C, and 2K.

Further, the image forming portions 1Y, 1M, 1C, and 1K include development units 24Y, 24M, 24C, and 24K (hereinafter, also collectively and simply referred to as “development unit 24”) as development portions that develop an electrostatic latent image on the photoconductive drum 2 with a toner and develop a toner image of each color on the photoconductive drum 2. Note that Y, M, C, and K appended to the reference numerals indicate colors of toners.

The image forming apparatus 100 illustrated in FIGS. 2 and 3 is an image forming apparatus that adopts a so-called “lower surface exposure system” that exposes the photoconductive drum 2 from below. In the image forming apparatus 100 adopting the lower surface exposure system, the exposure head 4 is disposed below the photoconductive drum 2. Hereinafter, a description will be made on the premise of an image forming apparatus adopting a lower surface exposure system. Note that, although not illustrated, as an embodiment, an image forming apparatus adopting an “upper surface exposure system” that exposes the photoconductive drum from above may be used.

The image forming apparatus 100 includes an intermediate transfer belt 9 to which a toner image formed on the photoconductive drum 2 is transferred, and a primary transfer roller 6 (Y, M, C, K) that sequentially transfers the toner image formed on the photoconductive drum 2 to the intermediate transfer belt 9. The intermediate transfer belt 9 is disposed above the image forming portion 1. In addition to the intermediate transfer method using the intermediate transfer belt 9, a direct transfer method of directly transferring a toner image from the photoconductive drum 2 to a sheet may be used.

In addition, the image forming apparatus 100 includes a secondary transfer roller 16 as a transfer portion that transfers the toner image on the intermediate transfer belt 9 onto a recording sheet P conveyed from a feeding portion 11, and a fixing device 19 as a fixing portion that fixes a secondarily transferred image onto the recording sheet P. The secondary transfer roller 16 abuts on a belt driving roller 10 of the intermediate transfer belt 9 with a predetermined pressing force via the intermediate transfer belt 9 to form a secondary transfer portion T2 with the intermediate transfer belt 9.

Toner bottles 22Y, 22M, 22C, and 22K (hereinafter, also collectively and simply referred to as “toner bottle 22”) that accommodate replenishment toners of the respective colors are detachably replaceable units with respect to the image forming apparatus 100. The toner bottle 22 is disposed above the intermediate transfer belt 9. In the toner bottle 22, an appropriate amount of toner is appropriately supplied from the corresponding toner bottle to each of the development units included in the four image forming portions by a toner supply mechanism (not illustrated).

In addition, the image forming apparatus 100 includes the feeding portion 11 that feeds the recording sheet P. The feeding portion 11 includes sheet cassettes 12a and 12b, feeding rollers 13a and 13b, and a registration roller 15. The sheet cassettes 12a and 12b are disposed below the image forming portion 1. The recording sheets P stored in the sheet cassettes 12a and 12b are fed one by one by the feeding rollers 13a and 13b, and conveyed to the secondary transfer portion T2 at a predetermined timing by the registration roller 15.

Further, the image forming apparatus 100 includes a duct unit 60 in a detachable manner. The duct unit 60 is disposed below the image forming portion 1 and above the feeding portion 11. The duct unit 60 is an exposure cooling unit that communicates with the exposure head 4 and generates an air flow for cooling the exposure head 4.

### (Image Forming Process)

Next, an image forming process of the image forming apparatus 100 will be briefly described. The charging roller 3Y charges the surface of the photoconductive drum 2Y. The exposure head 4Y exposes the surface of the photoconductive drum 2Y charged by the charging roller 3Y. As a result, an electrostatic latent image is formed on the photoconductive drum 2Y. Next, the development unit 24Y develops the electrostatic latent image formed on the photoconductive drum 2Y with a yellow toner. The yellow toner image developed on the surface of the photoconductive drum 2Y is transferred onto the intermediate transfer belt 9 by the primary transfer roller 6Y. Magenta, cyan, and black toner images are also formed through a similar image forming process, and are transferred to be superimposed on the intermediate transfer belt 9.

The toner image of each color transferred onto the intermediate transfer belt 9 is conveyed to the secondary transfer portion T2 by the intermediate transfer belt 9. The toner images conveyed to the secondary transfer portion T2 are collectively transferred to the recording sheet P conveyed from the feeding portion 11 by the secondary transfer roller 16. The recording sheet P to which the toner images have been transferred is conveyed to the fixing device 19. The fixing device 19 fixes the toner images onto the recording sheet P with heat and pressure. The recording sheet P subjected to the fixing process by the fixing device 19 is discharged to a discharge tray 21 disposed above the toner bottle 22 by a discharge roller 20.

### (Drum Unit and Development Unit)

The replaceable drum unit 23 and the development unit 24 in the image forming apparatus 100 of the present embodiment will be described by way of example.

Drum units 23Y, 23M, 23C, and 23K (hereinafter, also collectively and simply referred to as “drum unit 23”) including the photoconductive drums 2 are attached to the image forming apparatus 100. The drum unit 23 is a cartridge in which the photoconductive drum 2, the charging roller 3, and a cleaning device (not illustrated) are integrated, and is detached from the apparatus body of the image forming apparatus 100 and replaced by an operator such as a user or a maintenance person. The drum unit 23 rotatably supports the photoconductive drum 2. Specifically, the photoconductive drum 2 is rotatably supported by a frame body of the drum unit 23. The drum unit 23 may have a configuration of not including the charging roller 3 or the cleaning device.

In addition, development units 24Y, 24M, 24C, and 24K (hereinafter, also collectively and simply referred to as “development unit 24”) separate from the drum unit 23, which is a photoconductor unit, are attached to the image forming apparatus 100. The development units 24 include development sleeves 5Y, 5M, 5C, and 5K (hereinafter, also collectively and simply referred to as “development sleeve 5”) as developer bearing members that bear developers, and screws 7Y, 7M, 7C, and 7K (hereinafter, also collectively and simply referred to as “screw 7”) that supply the developers to the development sleeves 5 and stir the developers. The development unit 24 is a cartridge in which the development sleeve 5 and the screw 7 are integrated, and is detached from the apparatus body of the image forming apparatus 100 and replaced by an operator.

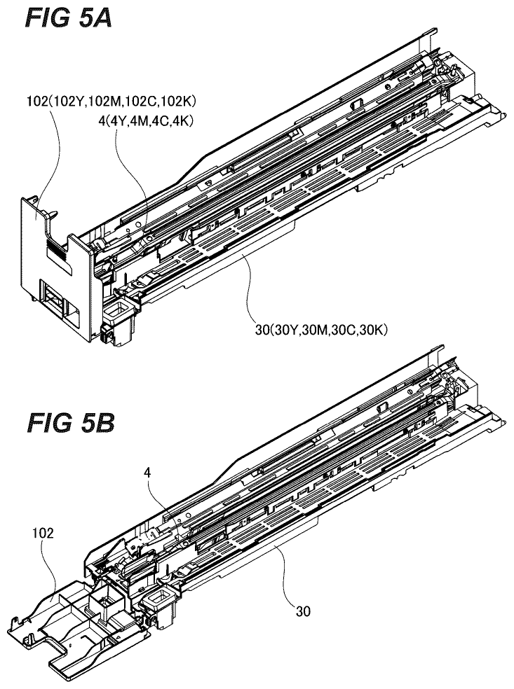

In addition, the image forming apparatus 100 includes a cartridge tray 30 (30Y, 30M, 30C, 30K) for each image forming portion (see FIGS. 5A and 5B). The cartridge tray 30 supports the drum unit 23 and the development unit 24 for each image forming portion. The drum unit 23 and the development unit 24 are guided in the axial direction of the photoconductive drum by the cartridge tray 30 for each image forming portion, and are inserted into and removed from the apparatus body of the image forming apparatus 100.

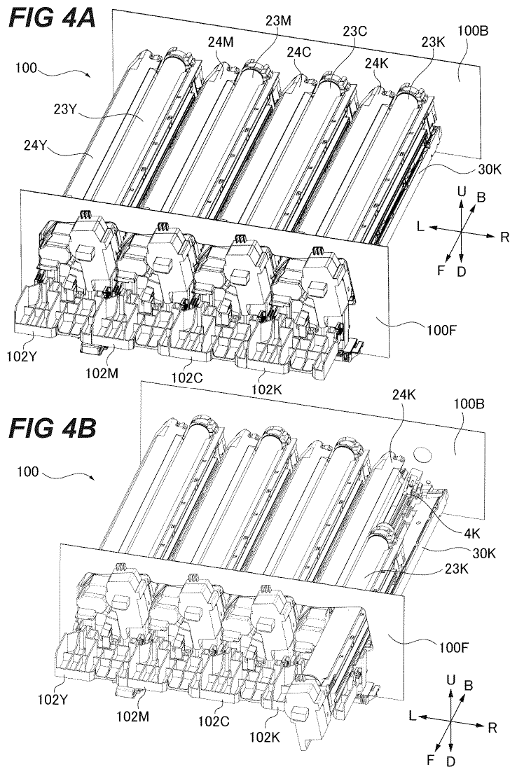

As illustrated in FIGS. 4A and 4B, one side of the cartridge tray 30 is attached to a front plate 100F and the other side is attached to a rear plate 100B in the axial direction of the photoconductive drum. The front plate 100F is formed of a sheet metal, and forms a part of a casing of the apparatus body on the front side of the apparatus body of the image forming apparatus 100. The rear plate 100B is formed of a sheet metal, and forms a part of a casing of the apparatus body on the back side of the apparatus body of the image forming apparatus 100. The front plate 100F and the rear plate 100B are disposed to face each other on one side and the other side in the axial direction of the photoconductive drum, and a sheet metal (not illustrated) as a beam bridges therebetween. Each of the front plate 100F, the rear plate 100B, and a beam (not illustrated) configures a part of a frame body (casing) of the image forming apparatus. Here, regarding the image forming apparatus of the present embodiment or the constituent members thereof, the front side is a side on which the drum unit 23 and the development unit 24 are taken in and out (inserted and removed) with respect to the apparatus body of the image forming apparatus 100.

The drum unit 23 and the development unit 24 deteriorate due to repetition of the image forming process, and thus take the form of a unit (cartridge) that can be maintained through replacement or attachment/detachment.

FIG. 3 illustrates disposition of the drum unit 23, the development unit 24, and the exposure head 4 when replacement or attachment/detachment is performed. In the image forming apparatus illustrated in FIG. 3, unlike the image forming apparatus illustrated in FIG. 2, it can be seen that the development unit 24 and the exposure head 4 are retracted and separated from the photoconductive drum 2.

This is because, when a state in which the development unit 24 and the exposure head 4 are disposed close to the photoconductive drum 2 as illustrated in FIG. 2 is maintained, each unit may be damaged due to dynamic interference at the time of attachment and detachment of the unit, or the unit may not be able to be taken out.

Therefore, at the time of attaching and detaching the unit, the development unit 24 and the exposure head 4 are retracted and separated from the photoconductive drum 2 by a moving mechanism as illustrated in FIG. 3.

The drum unit 23 and the development unit 24 are inserted into and removed from the front side of the image forming apparatus 100, and are mounted at predetermined positions (mounting positions) of the apparatus body of the image forming apparatus 100.

The image forming apparatus 100 includes inner doors 102Y, 102M, 102C, and 102K (hereinafter, also collectively and simply referred to as “inner door 102”) that cover front sides of both the drum unit 23 and the development unit 24 mounted at the mounting position. The inner door 102 is axially supported on the front side of the cartridge tray 30 and is rotatable within a predetermined range with respect to the cartridge tray 30. That is, the inner door 102 is provided to be openable and closable with respect to the image forming apparatus.

Furthermore, a front cover 101 forming an exterior of the apparatus is provided on the front side of the image forming apparatus 100. One end of the front cover 101 is fixed to the front side of the apparatus body of the image forming apparatus 100 via a hinge, and is rotatable with respect to the apparatus body of the image forming apparatus 100 by the hinge. The front cover 101 is provided closer to the front side than the inner door 102 in the axial direction of the photoconductive drum. In the closed state illustrated in FIG. 1, the front cover 101 covers the entire plurality of inner doors 102 arranged in the left-right direction to form an exterior on the front side of the apparatus.

Therefore, replacement work of the drum unit 23 and the development unit 24 is performed by an operator in the following procedure. The operator opens the front cover 101, then opens the inner door 102 as illustrated in FIGS. 3A and 3B, and takes out the drum unit 23 or the development unit 24 in the apparatus body. The replacement work is completed by inserting the new drum unit 23 or development unit 24, closing the inner door 102, and further closing the front cover 101.

Although not illustrated, the image forming apparatus 100 according to the present embodiment includes a moving mechanism that moves the exposure head 4 to an exposure position or a retraction position (separation position) with respect to the photoconductive drum 2. The moving mechanism is provided in the image forming apparatus 100, and moves the exposure head 4 to the exposure position or a retraction position where the exposure head 4 is retracted from the exposure position.

In the present embodiment, the moving mechanism moves the exposure head 4 in a direction away from the photoconductive drum 2 in conjunction with the operation of opening the inner door 102 as illustrated in FIG. 5B, and retracts the exposure head 4 to the retraction position. On the other hand, as illustrated in FIG. 5A, the moving mechanism moves the exposure head 4 in a direction approaching the photoconductive drum 2 in conjunction with the operation of closing the inner door 102 and moves the exposure head 4 to the exposure position.

In the present embodiment, the moving mechanism moves not only the exposure head 4 but also the development unit 24 to a development position or a retraction position where the development unit 24 is retracted from the development position. That is, the moving mechanism moves the development unit 24 in a direction away from the photoconductive drum 2 in conjunction with the operation of opening the inner door 102, and retracts the development unit 24 to the retraction position. On the other hand, the moving mechanism moves the development unit 24 in a direction approaching the photoconductive drum 2 in conjunction with the operation of closing the inner door 102, and moves the development unit 24 to the development position.

Here, in the following description, the front plate side is defined as a front side, and the rear plate side is defined as a rear side (back side) with respect to the apparatus body. When the photoconductive drum 2K on which an electrostatic latent image related to a black toner image is formed is used as a reference, a side on which the photoconductive drum 2Y on which an electrostatic latent image related to a yellow toner image is formed is disposed is defined as a left side. When the photoconductive drum 2Y on which an electrostatic latent image related to a yellow toner image is formed is used as a reference, a side on which the photoconductive drum 2K on which an electrostatic latent image related to a black toner image is formed is disposed is defined as a right side. Furthermore, a direction perpendicular to the front-rear direction and the left-right direction defined here and upward in the up-down direction is defined as an up direction, and a direction perpendicular to the front-rear direction and the left-right direction defined here and downward in the up-down direction is defined as a down direction. The defined front direction F, rear direction B, left direction L, right direction R, up direction U, and down direction D are illustrated in FIG. 1.

In addition, the axial direction of the photoconductive drum 2 described below is a direction that coincides with the front-rear direction (front-back direction) illustrated in FIG. 1. The longitudinal direction of the exposure head 4 also coincides with the front-rear direction illustrated in FIG. 1. That is, the axial direction of the photoconductive drum 2 and the longitudinal direction of the exposure head 4 coincide with each other. In addition, one side in the axial direction of the photoconductive drum 2 is the front side defined here, and the other side in the axial direction is the rear side defined here. In addition, one side in the longitudinal direction of the exposure head 4 is the front side defined here, and the other side is the rear side defined here.

### (Exposure Head)

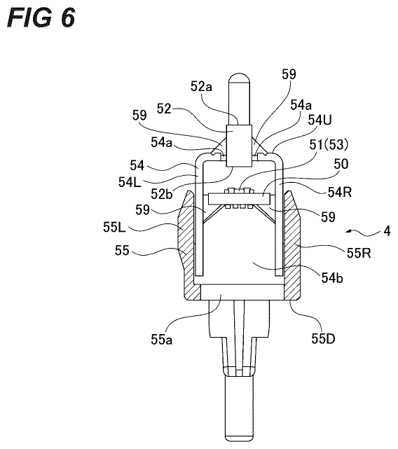

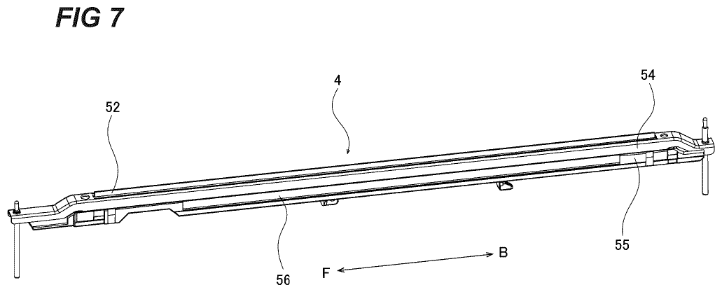

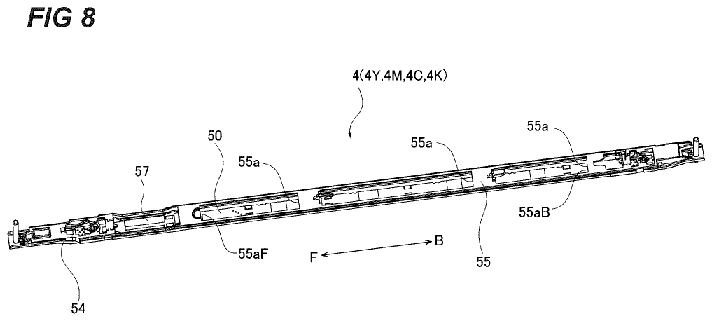

Next, the exposure head 4 will be described with reference to FIGS. 6 to 8. FIG. 6 is a schematic cross-sectional view of the exposure head 4 included in the image forming apparatus of the present embodiment. FIG. 7 is a perspective view of the exposure head 4 as viewed from above. FIG. 8 is a perspective view of the exposure head 4 as viewed from below.

Here, as an example of an exposure system adopted in an electrophotographic image forming apparatus, there is a laser beam scanning exposure system in which an irradiation beam of a semiconductor laser is applied by a rotating polygon mirror or the like, and a photoconductive drum is exposed through an f-θ lens or the like. The “exposure head 4” described in the present embodiment is used in an LED exposure system for exposing the photoconductive drum 2 using light emitting elements such as LEDs arranged along the rotational axis direction of the photoconductive drum 2, and is not used in the laser beam scanning exposure system described above.

As illustrated in FIGS. 7 and 8, the exposure head 4 has an elongated shape (longitudinal shape) extending in the axial direction of the photoconductive drum 2. As illustrated in FIG. 6, the exposure head 4 includes a substrate 50, a light emitting element mounted on the substrate 50, a lens array 52, a casing 54 that holds the substrate 50 and the lens array 52, and a casing support member 55 that supports the casing 54. Here, the exposure head 4 includes a light emitting diode (LED) 51 as a light emitting element that emits light.

### (Substrate and Lens Array)

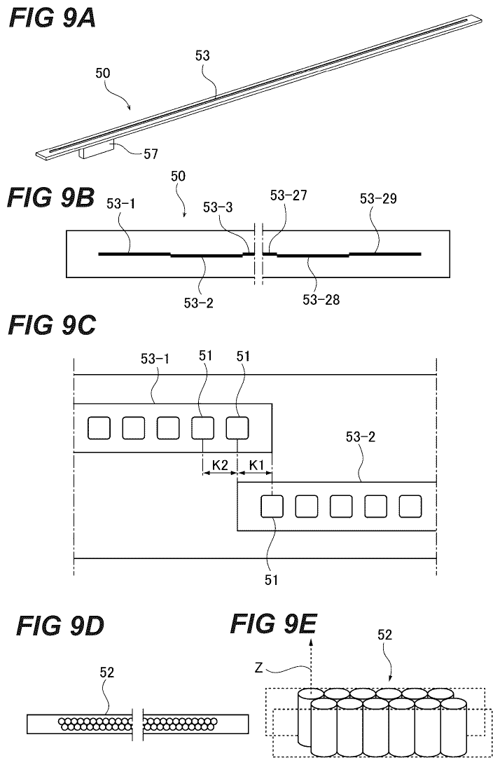

Here, the substrate 50 and the lens array 52 of the exposure head 4 will be described with reference to FIGS. 9A to 9E. First, the substrate 50 will be described. FIG. 9A is a schematic perspective view of the substrate 50. FIG. 9B illustrates an arrangement of a plurality of LEDs 51 provided on the substrate 50, and FIG. 9C is an enlarged view of FIG. 9B.

### (Substrate)

An LED chip 53 is mounted on the substrate 50. As illustrated in FIG. 9A, the LED chip 53 is provided on one surface of the substrate 50, and a long connector 57 is provided on the other surface. Here, one surface of the substrate 50 is a surface on a side where the LED chip 53 is provided (an upper surface or a front surface). The other surface of the substrate is a surface (a lower surface or a back surface) opposite to the side on which the LED chip 53 is provided.

The connector 57 is attached to the other surface (a lower surface or a back surface) of the substrate 50 such that the longitudinal direction thereof is along the longitudinal direction of the substrate 50. The long connector 57 is provided on the front side of the image forming apparatus 100 (one side in the longitudinal direction of the substrate 50). A wiring for supplying a signal to each LED chip 53 is provided on the substrate 50. One end of a flexible flat cable (not illustrated; hereinafter abbreviated as an FFC) as an example of a cable is connected to the connector 57.

Note that a control circuit portion of the image forming apparatus 100 is provided with a substrate (not illustrated) including a controller and a connector. The other end of the FFC is connected to the connector. That is, the FFC electrically connects the substrate (control circuit portion) of the apparatus body to the substrate 50 of the exposure head 4. A control signal (drive signal) is input to the substrate 50 of the exposure head 4 from the control circuit portion of the apparatus body of the image forming apparatus 100 via the FFC and the connector 57. The control signal is transferred to each LED chip 53 mounted on the substrate 50. The LED chip 53 is driven (turned on and turned off) by the control signal input to the substrate 50.

The LED chip 53 mounted on the substrate 50 will be described in more detail. As illustrated in FIGS. 9B and 9C, LED chips 53-1 to 53-29 (twenty-nine) in which a plurality of LEDs 51 (an example of light emitting elements) is disposed are arranged on one surface of the substrate 50. In each of the LED chips 53-1 to 53-29, 516 LEDs 51 are arranged in the longitudinal direction. In the longitudinal direction of the LED chip 53, a center-to-center distance k2 between the adjacent LEDs 51 corresponds to a recording resolution of the image forming apparatus 100. Since the recording resolution of the image forming apparatus 100 of the present embodiment is 1200 dpi, the LEDs 51 are arranged such that the center-to-center distance k2 of the adjacent LEDs 51 is 21.16 μm in the longitudinal direction of the LED chips 53-1 to 53-29. Therefore, an exposure range of the exposure head 4 of the present embodiment is about 314 mm. The length of the photoconductive layer in the axial direction of the photoconductive drum 2 is 314 mm or more. Since the length of the long side of the A4-size recording sheet and the length of the short side of the A3-size recording sheet are 297 mm, the exposure head 4 of the present embodiment has an exposure range in which an image can be formed on the A4-size recording sheet and the A3-size recording sheet.

The LED chips 53-1 to 53-29 are arranged in a staggered manner in the axial direction of the photoconductive drum 2. Specifically, the LED chips 53-1 to 53-29 are alternately arranged in two rows in the axial direction of the photoconductive drum 2. That is, as illustrated in FIG. 9B, odd-numbered LED chips 53-1, 53-3, . . . , and 53-29 counted from the left side are mounted in a line in the longitudinal direction of the substrate 50. Further, the even-numbered LED chips 53-2, 53-4, . . . , and 53-28 counted from the left side are mounted in a line in the longitudinal direction of the substrate 50. The LED chips 53 are disposed as described above. As a result, as illustrated in FIG. 9C, in the longitudinal direction of the LED chips 53, a center-to-center distance k1 of the LEDs 51 disposed at one end of one LED chip 53 and the other end of the other LED chip 53 in the different adjacent LED chips 53 can be made equal to the center-to-center distance k2 of the adjacent LEDs 51 on one LED chip 53.

In the present embodiment, the light emitting element is a semiconductor LED which is a light emitting diode, but may be, for example, an organic light emitting diode (OLED). This OLED is also called an organic electro-luminescence (EL) element, and is a current-driven light emitting element. OLEDs are disposed on a line in a main scanning direction (the axial direction of the photoconductive drum 2) on a thin film transistor (TFT) substrate, for example, and are electrically connected in parallel via a power supply wiring similarly provided in the main scanning direction.

### (Lens Array)

Next, the lens array 52 which is a lens assembly will be described. FIG. 9D is a schematic view of the lens array 52 as viewed from the photoconductive drum 2 side. FIG. 9E is a schematic perspective view of the lens array 52. As illustrated in FIG. 9D, the lens array 52 condenses light emitted from the light emitting element on the photoconductive drum 2. The lens array 52 is a lens assembly including a plurality of lenses. The plurality of lenses is arranged in two rows in the arrangement direction of the plurality of LEDs 51. The lenses are alternately disposed such that one of the lenses in the other row is disposed to be in contact with both of the adjacent lenses in the arrangement direction of the lenses in one row. Each lens is a cylindrical rod lens made of glass, and has a light incident surface 52b on which the light emitted from the LED 51 is incident and a light emission surface 52a from which the light incident from the light incident surface is emitted (see FIG. 6). A material of the lens is not limited to glass, and may be plastic. A shape of the lens is not limited to a cylindrical shape, and may be, for example, a polygonal prism shape such as a hexagonal prism shape.

A dotted line Z illustrated in FIG. 9E indicates an optical axis of the lens. The exposure head 4 is moved by the moving mechanism in a direction substantially along the optical axis of the lens indicated by the dotted line Z (hereinafter, also referred to as an optical axis direction). The optical axis of the lens here indicates a line connecting the center of the light emission surface of the lens to the focal point of the lens. The lens array 52 is a lens assembly having a plurality of lenses, and the “optical axis” described above is an optical axis of any lens among the plurality of lenses. Here, strictly speaking, the plurality of lenses included in the lens array 52 may be slightly inclined to each other. This is due to tolerance during assembly. However, the deviation in the degree of the tolerance mentioned here is not considered when the direction of the optical axis is defined. Therefore, it is considered that the optical axes of the plurality of lenses are in the same direction. Radiation light emitted from the LED 51 is incident on the lenses included in the lens array 52. The lens has a function of condensing the incident radiation light on the surface of the photoconductive drum 2.

An attachment position of the lens array 52 with respect to the casing 54 is adjusted at the time of assembling the exposure head 4 such that a distance between the light emission surface of the LED 51 and the light incident surface 52b of the lens is substantially equal to a distance between the light emission surface 52a of the lens and the surface of the photoconductive drum 2.

### (Casing)

As illustrated in FIG. 6, the casing 54 holds the lens array 52 and the substrate 50. In the present embodiment, the casing 54 is a metal member formed by bending a plate material obtained by plating a galvanized steel plate or a cold-rolled steel plate. For example, the casing 54 is formed through press working of a sheet metal such as a metal thin plate having a thickness of about 1 mm into a U shape.

The casing 54 has a reference portion (facing surface) 54U in which a first opening 54a into which the lens array 52 is inserted is formed. The reference portion 54U faces the photoconductive drum 2 in the optical axis direction of the lens of the lens array 52. The reference portion 54U is not limited to a flat surface, and may be a slightly curved surface. The casing 54 has an extending portion 54R extending in a direction away from the photoconductive drum 2 from one side in the lateral direction of the reference portion 54U. In addition, the casing 54 has an extending portion 54L extending in a direction away from the photoconductive drum 2 from the other side in the lateral direction of the reference portion 54U.

The extending portion 54R and the extending portion 54L form a substrate support portion for supporting the substrate 50 inserted from the second opening 54b in the casing 54. The reference portion 54U and the substrate support portion (extending portions 54R and 54L) are integrated to form the casing 54 that holds the lens array 52 and the substrate 50, and a cross section thereof is formed in a substantially U shape. Since the casing 54 is formed in a substantially U shape, the second opening 54b is formed on the side opposite to the reference portion 54U. The second opening 54b is formed between the substrate support portions (extending portions 54L and 54R) extending from the reference portion 54U to the side away from the photoconductive drum. That is, the second opening 54b of the casing 54 is formed between substrate support portions (extending portions 54R and 54L) that support one side and the other side of the substrate 50 in a direction orthogonal to the optical axis direction and the axial direction.

The first opening 54a of the casing 54 is an opening slightly larger than the lens array 52, and is a lens attachment portion into which the lens array 52 is inserted. As described above, the lens array 52 is adhesively fixed to the casing 54 at a plurality of locations in the longitudinal direction via an adhesive 58 after an attachment position with respect to the casing 54 is adjusted at the time of assembling the exposure head 4. Since the first opening 54a of the casing 54 is an opening slightly larger than the lens array 52, the lens array 52 is fixed to the casing 54 via the adhesive 58 in a state in which there is a slight gap in the lateral direction orthogonal to the longitudinal direction.

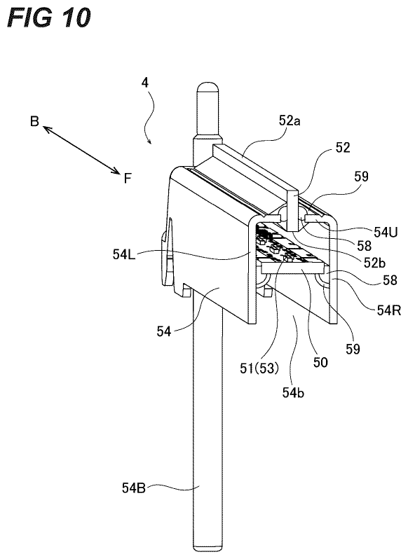

Further, the substrate 50 is formed slightly smaller than the casing 54. In other words, the second opening 54b of the casing 54 is an opening slightly larger than the substrate 50, and is a substrate attachment portion into which the substrate 50 is inserted. The attachment position of the substrate 50 is adjusted so that the optical axis of the LED 51 is aligned with the center of the lens array 52 between wall surfaces (extending portions 54R and 54L) of the casing 54 on both sides of the substrate 50 in the lateral direction. Thereafter, the substrate 50 is adhesively fixed to the casing 54 at a plurality of locations in the longitudinal direction via the adhesive 58 (see FIG. 10). Since the second opening 54b of the casing 54 is an opening slightly larger than the substrate 50, the substrate 50 is also fixed to the casing 54 via the adhesive 58 in a state in which there is a slight gap in the lateral direction.

The adhesive 58 is, for example, an ultraviolet curable adhesive, and is cured by being applied to an adhesion site in a liquid or gel state and then irradiated with ultraviolet rays. Note that adhesion points of the adhesive 58 are provided at the same positions on the left and right at a plurality of locations in the longitudinal direction, but are not limited thereto.

At the time of assembling the exposure head 4, a gap with the casing 54 of the substrate 50 adhesively fixed to the casing 54 is further sealed with a sealant 59. Similarly, the gap between the lens array 52 adhesively fixed to the casing 54 and the casing 54 is sealed with the sealant 59.

The sealant 59 seals the gap by using a moisture-curable silicone resin. The sealant 59 is not limited to the moisture-curable resin, and may be, for example, a photocurable adhesive, a foamed sealing material made of a sponge material, or the like.

### (Pilot Hole of Casing)

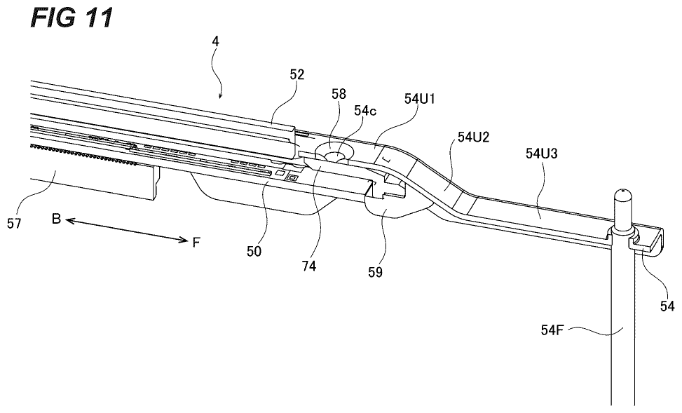

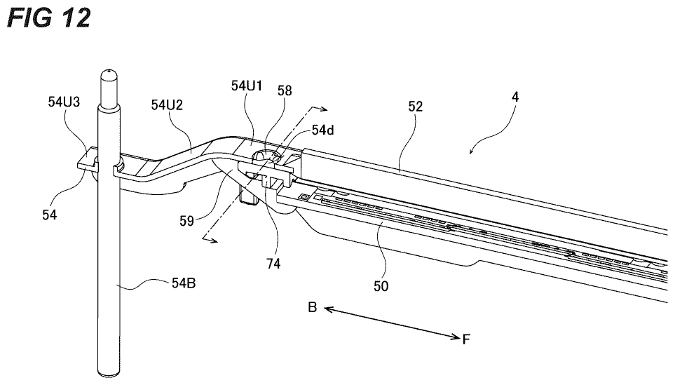

As illustrated in FIGS. 11 and 12, the casing 54 has a reference surface 54U1 having a first opening (elongated hole) 54a into which the lens array 52 is inserted. Further, the casing 54 has a pin fixing surface 54U3 offset in a direction away from the photoconductive drum 2 with respect to the reference surface 54U1 via a joggle shape 54U2 on both sides of the reference surface 54U1 in the longitudinal direction. The positioning pin described above is fixed to the pin fixing surface 54U3 of the casing 54.

The reason why the pin fixing surface 54U3 is offset in the direction away from the photoconductive drum 2 with respect to the reference surface 54U1 is to prevent interference with a separation mechanism (not illustrated) that separates the charging roller 3 from the photoconductive drum 2 in the image forming apparatus 100. This separation mechanism suppresses the occurrence of crushing on the charging roller side and periodic density unevenness of a nip width of the photoconductive drum 2 due to a state in which the photoconductive drum 2 and the charging roller 3 are in close contact with each other at the same phase during non-driving.

The casing 54 has pilot holes 54c and 54d for positioning a pilot pin of a mold when a sheet metal is pressed. The pilot holes 54c and 54d are openings that are provided on the reference surface 54U1 of the casing 54 and allow the outside and the inside of the casing 54 to communicate with each other. In other words, the casing 54 has at least one opening (hole) that allows the outside and the inside of the casing 54 to communicate with each other separately from the first opening 54a and the second opening 54b.

Here, the pilot holes 54c and 54d for positioning the pilot pins of the mold at the time of press working are exemplified as holes of the casing 54, but are not limited thereto, and may be holes provided separately from the above-described pilot holes.

In the press working, it is preferable to make the reference surface 54U1 as wide as possible, and it is necessary to provide two pilot holes 54c and 54d on the reference surface 54U1 at intervals as much as possible. Therefore, in the present embodiment, as illustrated in FIGS. 11 and 12, the pilot holes 54c and 54d are provided at both ends in the longitudinal direction of the reference surface 54U1 of the casing 54. The pilot holes 54c and 54d are provided outside the first opening 54a in the longitudinal direction of the reference surface 54U1 of the casing 54. The pilot holes 54c and 54d are provided in a region sealed by the sealant 59 of the casing 54.

The casing 54 has the pilot hole 54c that is a first hole and the pilot hole 54d that is a second hole smaller in diameter than the first hole. Here, the diameter of the pilot hole 54c on the front side is ϕ5, and the diameter of the pilot hole 54d on the rear side is ϕ4 different therefrom. This makes it possible to prevent the pilot pin of the mold from being reversed at the time of press working using the mold.

On both sides of the casing 54 in the longitudinal direction, sealing auxiliary members 74 as abutment members abutting on surfaces around the pilot holes 54c and 54d of the casing 54 are provided. The sealing auxiliary member 74 has an abutment surface larger than the pilot holes 54c and 54d of the casing 54. Since the sealing auxiliary member 74 abuts on the surfaces around the holes from the lower side of the pilot holes 54c and 54d, the pilot holes 54c and 54d on both sides of the casing 54 are closed by the sealing auxiliary member 74.

Here, a material of the sealing auxiliary member 74 is a resin material (polycarbonate ABS) having both characteristics of polycarbonate (PC) and ABS. In addition, the sealing auxiliary member 74 is a component in which an abutment surface abutting on the surfaces around the pilot holes 54c and 54d is defined as a flatness of 0.1 mm and an arithmetic average roughness Ra of 6.3. Note that the material of the sealing auxiliary member 74 and the flatness and roughness of the abutment surface are examples, and are not limited thereto.

As illustrated in FIGS. 11 and 12, the sealing auxiliary member 74 is fixed to the casing 54 with the sealant 59 in a state in which the sealing auxiliary member 74 abuts on the surfaces around the holes of the lower side of the pilot holes 54c and 54d of the casing 54. As a result, the pilot holes 54c and 54d of the casing 54 are closed from below by the sealing auxiliary member 74.

In addition, as illustrated in FIGS. 11 and 12, at both ends of the exposure head 4 in the longitudinal direction, a space between the sealing auxiliary member 74 and the substrate 50 and a space between the sealing auxiliary member 74 and the casing 54 are also sealed with the sealant 59.

That is, as illustrated in FIGS. 10, 11, and 12, except for the portions of the pilot holes 54c and 54d, the gap between the substrate 50 and the casing 54, the gap between the lens array 52 and the casing 54, and the gap between the sealing auxiliary member 74 and the casing 54 are all sealed with the sealant 59. This prevents foreign matter from entering the optical path from the light emitting element to the lens array. A space from the light emitting element (LED 51) to the lens array 52 inside the exposure head 4 substantially sealed as described above will also be hereinafter referred to as a sealed space.

The pilot holes 54c and 54d of the casing 54 are configured to be substantially sealed by the abutment surface of the sealing auxiliary member 74 having surface roughness abutting on the surfaces around the holes from the lower side, and are not completely sealed. Therefore, there is a possibility that an air flow passing through the inside of the sealed space of the exposure head 4 in the longitudinal direction is generated using the two pilot holes 54c and 54d as an inlet and an outlet, respectively.

Therefore, in the present embodiment, the boundary between the edge of the front pilot hole 54c having a relatively large diameter and having a high possibility of foreign matter intrusion and the sealing auxiliary member 74 is completely sealed with the adhesive 58. That is, the one pilot hole 54c is completely sealed with the adhesive 58 by applying the adhesive 58 over the entire circumference of the boundary between the abutment surface of the sealing auxiliary member 74 abutting on the surface around the one pilot hole 54c from the lower side and the edge of the one pilot hole 54c.

Further, the other pilot hole 54d is partially sealed with the adhesive 58 by applying the adhesive 58 over a half circumference of the boundary between the abutment surface of the sealing auxiliary member 74 abutting on the surface around the other pilot hole 54d from the lower side and the edge of the other pilot hole 54d. In other words, the pilot hole 54d has a portion (here, a half circumference) to which the adhesive 58 is not applied, and is not partially sealed.

In particular, the exposure head 4 is disposed with the optical axis direction inclined by a predetermined angle (here, 15°) with respect to a straight line in the vertical direction taking the rotation center (axis) of the photoconductive drum 2 so that the emitted light perpendicularly strikes the surface of the photoconductive drum 2. Therefore, it is conceivable that foreign matter enters from the substantially sealed rear pilot hole 54d due to gravity. Therefore, when the exposure head 4 is disposed in an inclined manner, a half circumference of the pilot hole 54d on the lower side is sealed with the adhesive 58.

As described above, the pilot holes 54c and 54d of the casing 54 are substantially sealed with the adhesive 58 serving as a sealant.

With the above configuration, it is possible to discharge a gas such as an outgas of the sealant to the outside while preventing entry of foreign matter into the sealed space from the light emitting element (LED 51 or the LED chip 53) of the exposure head 4 to the lens array 52.

Here, sealing of the pilot holes 54c and 54d is performed by the adhesive 58 instead of the sealant 59, but this is because a region to be sealed is narrow, and control and management related to a shape of an agent, such as a viscosity and a curing time of the agent, are required. For example, when a photocurable adhesive is used, it is easy to control and manage a shape of the adhesive by irradiating the adhesive with light immediately after application.

That is, a sealant for sealing the pilot holes 54c and 54d is the adhesive 58. The boundary between the sealing auxiliary member 74 and the edge of each of the pilot holes 54c and 54d is sealed by applying the adhesive 58 to bridge the sealing auxiliary member 74 abutting on the surface around each of the pilot holes 54c and 54d from the lower side and the edge of each of the pilot holes 54c and 54d.

Using the exposure head 4 having the above configuration, it was confirmed through air flow simulation whether particles having a particle size of 6.5 μm imitating the toner from the pilot hole 54d were attached onto the surface of the LED chip 53. Conditions of this simulation were as follows.

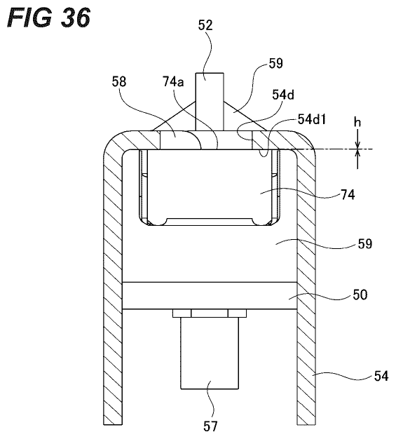

First, an air flow in and out of the pilot hole 54d, which is generated when the air in the sealed space of the exposure head 4 increases in temperature and expands or decreases in temperature and contracts by turning on/off the LED chip 53, is reproduced. Further, a gap h (see FIG. 36) between a surface 54d1 around the hole of the casing 54 and an abutment surface 74a of the sealing auxiliary member 74 in the pilot hole 54d is set to 200 μm on the assumption of the worst based on the flatness of the surface around the hole of the casing 54 and the abutment surface of the sealing auxiliary member 74 abutting on the surface. FIG. 36 is a cross-sectional view of the exposure head 4 taken along a portion of the pilot hole 54d in FIG. 12 (a portion indicated by an arrow in the drawing).

Under the above conditions, an initial velocity was applied to the particles in a space without a flow field, and how the particles entered the inside was confirmed. As a result, it was confirmed that there was no particle adhering to the surface of the LED chip 53, and there is a low possibility that particles enter the sealed space from the gap h between the casing 54 and the sealing auxiliary member 74 in the pilot hole 54d.

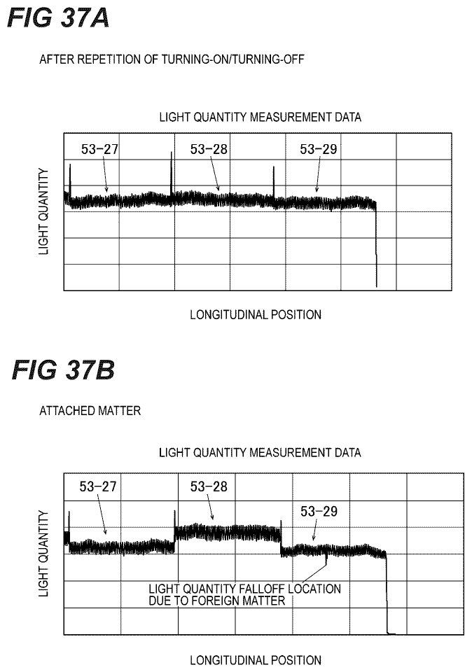

The presence or absence of foreign matter entering from the pilot hole 54d was also confirmed through examination based on actual measurement. In this examination, in a case where the LED chip 53 was repeatedly turned on and off as described above to generate an air flow in the pilot hole 54d portion in a state in which the toner is sprinkled to the pilot hole 54d portion, entry of the toner was checked. The LED chip 53 was turned on and off for 5 minutes each, and was repeatedly turned on and off until a total turning-on time reached 60 hours in consideration of the product life. FIG. 37A illustrates light quantity measurement data after the examination. Note that FIG. 37B illustrates a comparative example, and illustrates light quantity data in a case where local light quantity falloff due to foreign matter occurs. In FIGS. 37A and 37B, data of the three LED chips 53-27, 53-28, and 53-29 at the rear end where the pilot hole 54d is provided is extracted and illustrated. As illustrated in FIG. 37A, in the exposure head 4 having the above configuration, the local light quantity falloff illustrated in FIG. 37B was not observed in the three LED chips 53-27, 53-28, and 53-29 close to the pilot hole 54d. From this result, in the exposure head 4 having the above configuration, it was possible to confirm that there was no influence on the light quantity after the examination even under the severe condition of sprinkling fine particles such as toner on the pilot hole 54d as in the present examination.

In addition, as a result of actually measuring the surface roughness of the sealing auxiliary member 74 and the casing 54, it was confirmed that the arithmetic mean roughness is about Ra2.6 and Ra1.0, respectively, and a total of 40 is a minute gap of about Ra6.2. In the exposure head 4 manufactured with the configuration as described in the present embodiment, a phenomenon was not confirmed in which the outgas of the sealant 59 breaks the sealant 59 and is released to the outside.

From the results of the above simulation and actual measurement, it was confirmed that a gas such as an outgas of the sealant can be released to the outside while preventing entry of foreign matter into the sealed space of the exposure head 4 using a simple configuration as described in the present embodiment.

### (Casing Support Member)

As illustrated in FIG. 6, the casing support member 55 supports the casing 54 holding the substrate 50 and the lens array 52. One end and the other end in the longitudinal direction of the casing support member 55 are fixed to the casing 54 via a coupling member (not illustrated) such as an ultraviolet curable adhesive, and thus the casing support member 55 is provided integrally with the casing 54. The casing support member 55 is a member having a longitudinal shape extending in the axial direction of the photoconductive drum 2. The casing support member 55 is formed in a U shape. The casing support member 55 includes a right side wall 55R which is a first facing portion, a left side wall 55L which is a second facing portion facing the right side wall 55R with the casing 54 interposed therebetween, and a bottom surface portion 55D which is disposed between the right side wall 55R and the left side wall 55L and faces the reference portion 54U of the casing 54. The bottom surface portion 55D, the right side wall 55R, and the left side wall 55L are integrated, and form the casing support member 55 forming a duct serving as a flow path of an air flow between the casing 54 and the casing support member 55, and a cross section of the casing support member 55 is formed in a substantially U shape. The bottom surface portion 55D of the casing support member 55 is provided with a plurality of openings 55a in the longitudinal direction which is the axial direction of the photoconductive drum 2.

The opening 55a of the casing support member 55 is provided at a position facing a surface (the back surface of the substrate 50) of the substrate 50 opposite to the mounting surface (the front surface of the substrate 50) on which the LED 51 is mounted. The opening 55a is provided between the right side wall 55R and the left side wall 55L in the lateral direction orthogonal to the longitudinal direction.

The right side wall 55R is a first facing portion facing the extending portion 54R which is a substrate support portion on one side of the casing 54 in the lateral direction. The right side wall 55R which is the first facing portion is provided between the casing 54 and the drum unit 23 which is an adjacent portion adjacent to the casing 54 on one side in the lateral direction orthogonal to the axial direction of the photoconductive drum 2. The right side wall 55R is provided over the axial direction of the photoconductive drum 2 to separate the casing 54 and the drum unit 23.

The left side wall 55L is a second facing portion facing the extending portion 54L which is a substrate support portion on the other side of the casing 54 in the lateral direction and facing the right side wall 55R with the casing 54 interposed therebetween. The left side wall 55L which is the second facing portion is provided between the casing 54 that holds the substrate 50 and the development unit 24 which is a development portion on the other side in the lateral direction. Similarly to the right side wall, the left side wall 55L is provided over the axial direction of the photoconductive drum 2 to separate the casing 54 and the development unit 24.

Since the casing support member 55 is provided integrally with the casing 54, the air flow sent from the duct unit 60 is blown onto the back surface of the substrate 50 through the opening 55a of the casing support member 55. Moreover, the air flow blown onto the back surface of the substrate 50 is blown in a direction orthogonal to the back surface of the substrate 50.

As described above, the casing support member 55 is provided over the longitudinal direction which is the axial direction of the photoconductive drum 2, and has the opening 55a at a position facing the back surface of the substrate 50. As a result, the air flow sent from the duct unit 60 is blown onto the back surface of the substrate 50 through the opening 55a of the casing support member 55. The casing support member 55 of the exposure head 4 forms a duct (closed space) between the casing support member 55 and the casing 54 for circulating the air flow blown toward the back surface side of the substrate 50 through the opening 55a in the longitudinal direction of the substrate 50. That is, the casing support member 55 forms a duct for circulating an air flow between the casing 54 and the casing support member 55, and forms a part of the duct for cooling the exposure head 4.

As described above, the exposure head 4 is configured as an integrated head unit by the substrate 50 including the LED 51, the lens array 52 including a plurality of lenses, the casing 54, and the casing support member 55.

### (Moving Mechanism)

The moving mechanism of the exposure head 4 includes a lifting/lowering duct 69, a rotating arm 65, and a link member (not illustrated). In the present embodiment, the moving mechanism has a function of moving not only the exposure head 4 but also the development unit 24 to the development position or the retraction position where the development unit 24 is retracted from the development position. The configuration of the moving mechanism is an example and is not limited thereto.

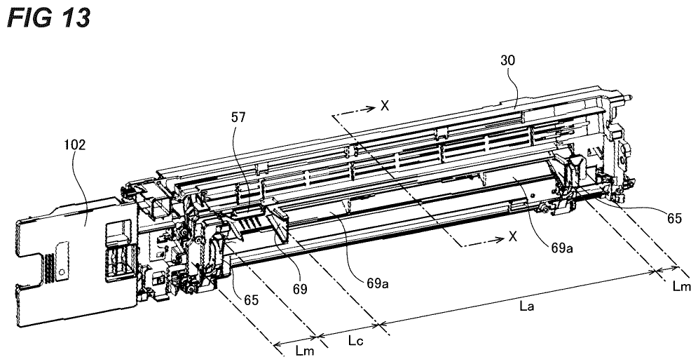

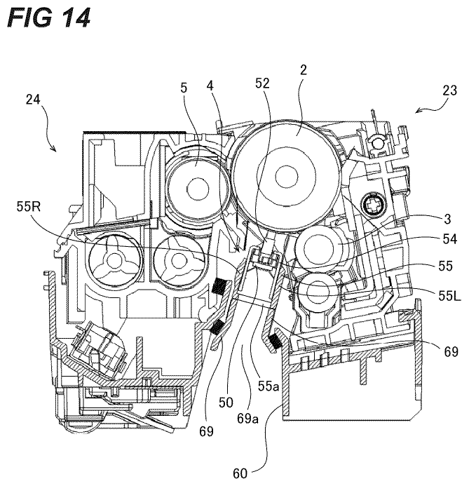

The moving mechanism including the lifting/lowering duct 69 and the rotating arm 65 will be described with reference to FIGS. 13 and 14. FIG. 13 is a perspective view of the cartridge tray as viewed from below. FIG. 14 is a cross-sectional view of the exposure head taken along line X-X in FIG. 13 when viewed from the front.

The lifting/lowering duct 69 is an exposure support member that detachably supports the exposure head 4, and is provided in the apparatus body of the image forming apparatus 100 together with the cartridge tray 30.

The lifting/lowering duct 69 is provided at a tray center portion corresponding to a space between a development support portion that supports the development unit 24 of the cartridge tray 30 and a drum support portion that supports the drum unit 23. The lifting/lowering duct 69 is provided at the tray center of the cartridge tray 30 to be movable to an exposure position where the photoconductive drum 2 is exposed and a retraction position where the photoconductive drum 2 is retracted from the exposure position. Both ends of the lifting/lowering duct 69 in the longitudinal direction are supported from below by the rotating arm 65. The lifting/lowering duct 69 is moved in a direction (moving direction) orthogonal to the axial direction of the photoconductive drum 2 integrally with the exposure head 4 by the rotating arm 65. The lifting/lowering duct 69 is moved to the exposure position or the retraction position by the rotation of the rotating arm 65.

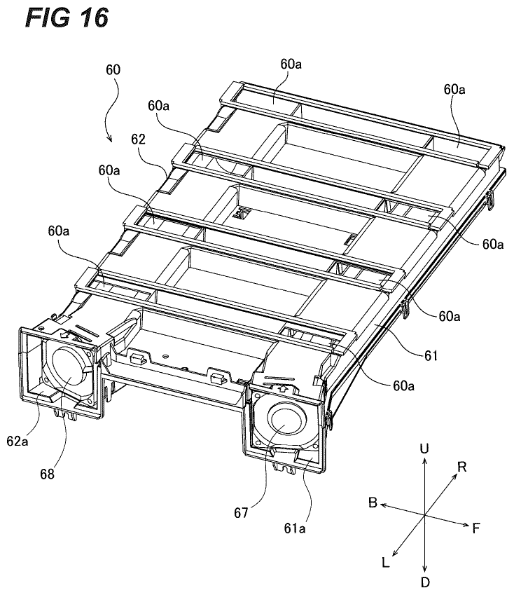

The lifting/lowering duct 69 has a longitudinal shape extending in the front-rear direction (the axial direction of the photoconductive drum) similarly to the exposure head 4 to be able to support the entire exposure head 4, and a central portion thereof has a shape having openings in the vertical direction. In the lifting/lowering duct 69, one opening (not illustrated) communicates with the opening 55a of the exposure head 4, and the other opening 69a (see FIG. 13) communicates with an opening 60a (see FIG. 16) of the duct unit 60. The lifting/lowering duct 69 supports the exposure head 4 and forms a part of a duct (closed space) that allows the exposure head 4 to communicate with the duct unit 60 to form a flow path of an air flow for cooling the exposure head 4.

Therefore, the lifting/lowering duct 69 circulates the air flow generated by the duct unit 60 to the back surface of the substrate 50 of the exposure head 4 through the above-described upper and lower openings. Therefore, the lifting/lowering duct 69 can circulate the air flow generated by the duct unit 60 to the back surface of the substrate 50 of the exposure head 4 without leaking the air flow to the adjacent development unit 24 and drum unit 23 side, and the scattering of the toner inside the apparatus can be reduced.

Further, the rotating arms 65 that move the exposure head 4 to the exposure position close to the photoconductive drum 2 and the retraction position where the exposure head 4 is retracted from the exposure position are disposed at both ends of the lifting/lowering duct 69 in the longitudinal direction. The rotating arm 65 is rotatably provided on the development unit side of the cartridge tray 30. One end of the rotating arm 65 in the left-right direction orthogonal to the axial direction of the photoconductive drum 2 is rotatably supported about an axis parallel to the axial direction. The other end of the rotating arm 65 in the left-right direction supports both ends of a region (a range Lm in FIG. 13) outside the opening of the lifting/lowering duct 69 in the axial direction. The rotating arm 65 is configured to interlock with opening and closing of the inner door 102 by a link member (not illustrated).

In the lifting/lowering duct 69 illustrated in FIG. 13, a range of the opening forming the duct is denoted by La, and a range of the disposition of the rotating arm 65 is denoted by Lm. The range La of the opening of the lifting/lowering duct 69 is provided in the range Lm of the disposition of the rotating arms 65.

A range Lc in FIG. 13 is a region where the connector 57 of the exposure head 4 is provided, and is provided outside a duct region indicated by the range La in FIG. 13 and between the duct region and a region indicated by one range Lm in FIG. 13.

In addition, the range La forming the duct includes most of the substrate 50 on which the LED 51 is mounted, and the exposure head 4 can be sufficiently cooled by blowing the air flow to the range La. The range Lc is a mounting portion of the connector 57 of a signal line that transmits a drive signal to the substrate 50 on which the LED 51 is mounted. The range Lc is not provided with an opening for forming a duct, but is configured to enable necessary and sufficient cooling in the range La as described above.

As a result, the air taken in from the outside of the apparatus by the duct unit 60 is blown to the back surface of the substrate 50 from the opening 55a of the exposure head 4 through the lifting/lowering duct 69. The air flow blown from the opening 55a of the exposure head 4 to the back surface of the substrate 50 is discharged to the outside of the apparatus by the duct unit 60 through the lifting/lowering duct 69.

### (Duct Unit)

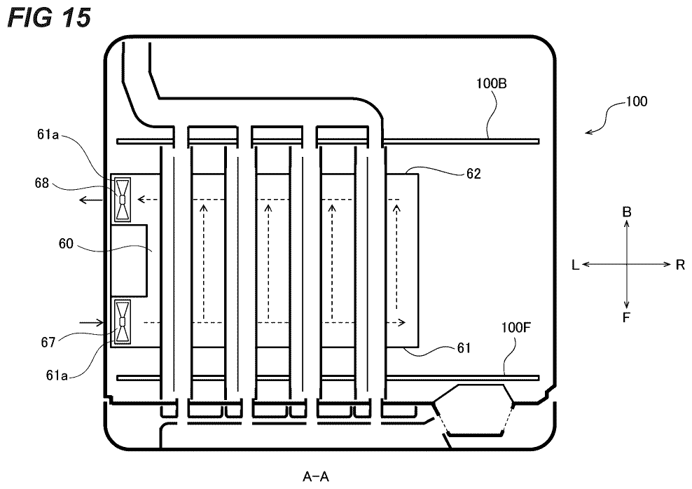

The image forming apparatus 100 also includes the duct unit 60 in a detachable manner. The duct unit 60 will be described with reference to FIGS. 15 and 16. FIG. 15 is a cross-sectional view of the image forming apparatus taken along line A-A in FIG. 1. FIG. 16 is a perspective view of the duct unit as viewed from above.

The duct unit 60 is an exposure cooling unit that communicates with the opening 69a formed by the cartridge tray 30 and the lifting/lowering duct 69 and cools the exposure head 4 with the air flow through the lifting/lowering duct 69.

The duct unit 60 includes an exhaust duct 62 that communicates with the lifting/lowering duct 69 and forms a space that circulates the air introduced from the lifting/lowering duct 69. On the upper surface of the exhaust duct 62, an opening 60a that communicates with the lifting/lowering duct 69 and introduces air from the lifting/lowering duct 69 is provided for each exposure head. The exhaust duct 62 is provided with a fan 68 that generates an air flow.

The duct unit 60 includes an intake duct 61 that communicates with the lifting/lowering duct 69 and forms a space that circulates air introduced into the lifting/lowering duct 69. On the upper surface of the intake duct 61, an opening 60a that communicates with the lifting/lowering duct 69 and introduces air into the lifting/lowering duct 69 is provided for each exposure head. The intake duct 61 is provided with a fan 67 that generates an air flow.

The duct unit 60 is integrally provided with the fans 67 and 68, the intake duct 61, and the exhaust duct 62, and is detachably attached to the apparatus body of the image forming apparatus 100 immediately below the cartridge tray 30.

Each opening 60a of the duct unit 60 is provided at a position facing the opening 69a of the lifting/lowering duct 69 for each exposure head, and is connected to the opening 69a to communicate with the exposure head 4 to form a closed space.

### (Cooling Configuration of Exposure Head)

Here, a cooling configuration of the exposure head will be described with reference to FIGS. 10 to 13. In FIG. 15, a flow of air for cooling the exposure head is indicated by a dashed line, and the flow of air indicated by the dashed line will also be referred to as an exposure cooling air flow.

Since the exposure head 4 dissipates heat according to a light emission amount of the LED 51 and is disposed close to a development device using toner weak against heat, a cooling portion is required. In particular, in a case where the image forming process is repeated at a high frequency, that is, in a case where the image forming process is used in a device with high productivity, or in a case where an image with high density is continuously output, the light emission time is long, and the light emission amount is also large. Thus, an amount of heat generated from the LED 51 and a circuit on the substrate 50 on which the LED 51 is mounted also increases.

As a countermeasure against this, for example, the casing 54 of the exposure head 4 is also used as a heat dissipation plate, and the exposure head 4 is configured to easily dissipate heat and hardly store heat. However, even in such a case, it is conceivable that the cooling of the exposure head 4 is not performed in time, heat storage proceeds, and the heat dissipated to the surroundings also increases. As a result, the toner around the development unit 24 and a part of the circulating toner inside the development unit may be fused, leading to an image defect.

Even in a case where the configuration for cooling the development unit 24 is provided, it is easily assumed that the heat storage caused by the light emission of the LED 51 is superior at a portion where the exposure head 4 is close. Therefore, it is desirable to provide a cooling configuration (exposure cooling air flow) of the exposure head 4 to reduce the amount of heat dissipated to the periphery of the exposure head 4.

The image forming apparatus 100 includes the exposure head 4, the lifting/lowering duct 69, the cartridge tray 30, and the duct unit 60. The exposure head 4 is attached to the lifting/lowering duct 69 disposed in the image forming apparatus 100, and is integrated with the lifting/lowering duct 69. When the exposure head 4 is attached to the lifting/lowering duct 69, the opening 55a (see FIG. 8) of the casing support member 55 of the exposure head 4 communicates with one opening (not illustrated) of the lifting/lowering duct 69. The lifting/lowering duct 69 forms a duct that allows the exposure head 4 and the duct unit 60 to communicate with each other. The duct unit 60 is attached immediately below the cartridge tray 30 with respect to the image forming apparatus 100. In other words, the duct unit 60 is provided on the side opposite to the photoconductive drum 2 with respect to the exposure head 4. When the duct unit 60 is attached to the image forming apparatus 100, the opening 60a (see FIG. 16) of the duct unit 60 communicates with the other opening 69a (see FIG. 14) of the lifting/lowering duct 69.

As described above, the casing support member 55, the lifting/lowering duct 69, the cartridge tray 30, and the duct unit 60 of the exposure head 4 form a cooling duct which is one continuous closed space. Each exposure head 4 is cooled by an exposure cooling air flow (dashed line illustrated in FIG. 15) flowing through the one closed space formed by the casing support member 55, the lifting/lowering duct 69, the cartridge tray 30, and the duct unit 60.

As illustrated in FIGS. 15 and 16, the fan 67 disposed closer to the front of the apparatus functions as an intake fan that takes air (fresh air) outside the apparatus into the duct unit 60. The fan 68 disposed closer to the rear side of the apparatus functions as an exhaust fan that exhausts air inside the duct unit 60 to the outside of the apparatus.

In the exposure cooling air flow indicated by a dashed line in FIG. 15, when the fan 67 and the fan 68 rotate, air outside the apparatus is introduced from an intake port 61a through a louver (not illustrated) provided in the exterior cover of the image forming apparatus. The air introduced from the intake port 61a is exhausted from each opening 60a of the intake duct 61 through the intake duct 61. The air exhausted from each opening 60a is blown to the exposure head 4 through the lifting/lowering duct 69. The air blown to the exposure head 4 through the lifting/lowering duct 69 is circulated from the apparatus front side to the apparatus rear side in the axial direction of the photoconductive drum 2, and is introduced into the exhaust duct 62 from each opening 60a of the exhaust duct 62 through the lifting/lowering duct 69. The air introduced from each opening 60a into the exhaust duct 62 is exhausted from an exhaust port 62a of the exhaust duct 62 to the outside of the apparatus through a louver (not illustrated) provided in the exterior cover.

The fans 67 and 68 in the duct unit 60 are controlled based on temperature detection sensors (not illustrated) disposed on the substrates 50 of the respective colors. As a result, the fan is not always rotating, but starts rotating when the temperature detected by the temperature detection sensor reaches a predetermined threshold. As described above, by minimizing the operation of the exposure cooling flow of the fan and also minimizing the air volume, the possibility of toner scattering to the inside of the apparatus is reduced also from the viewpoint of control.

### (Configuration of Preventing Outflow of Air Flow in Exposure Head)

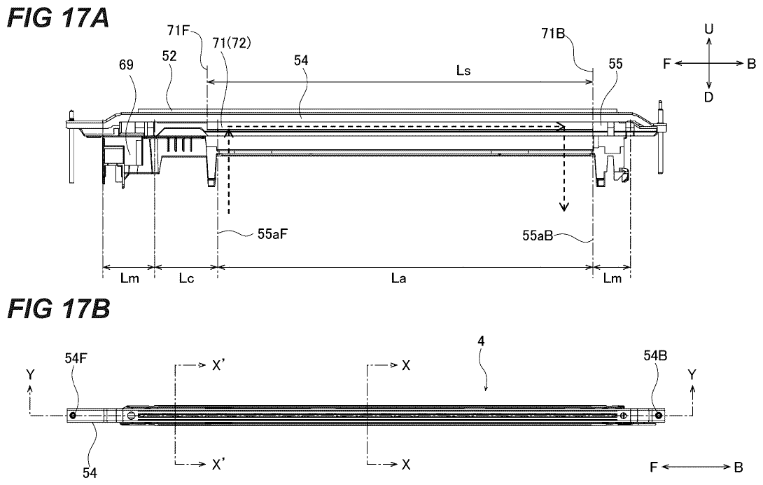

Next, a flow path of an air flow in the exposure head 4 and a configuration of preventing the air flow from flowing out will be described with reference to FIGS. 17A to 21.

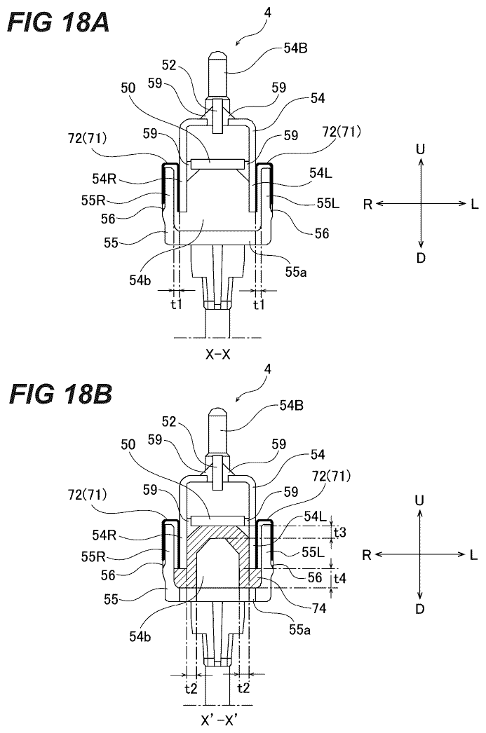

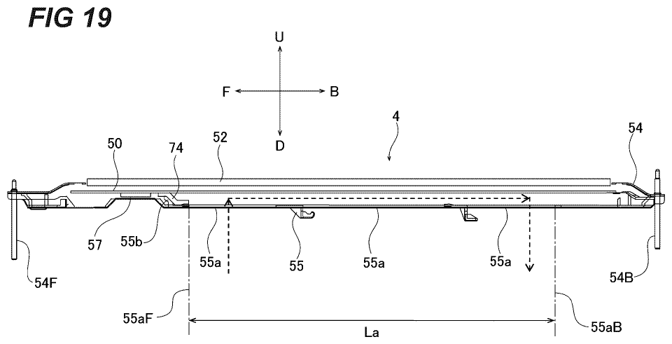

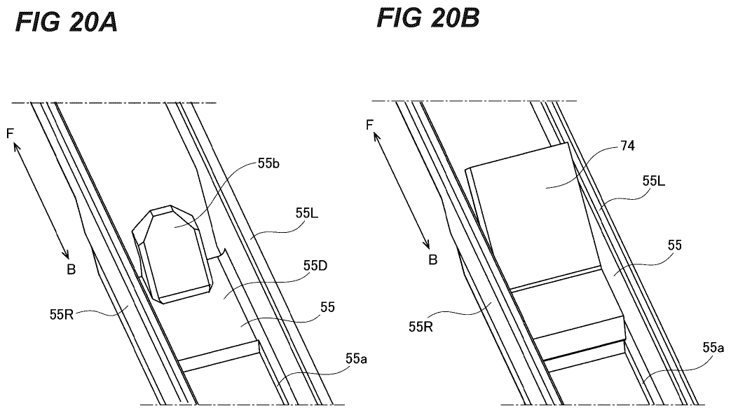

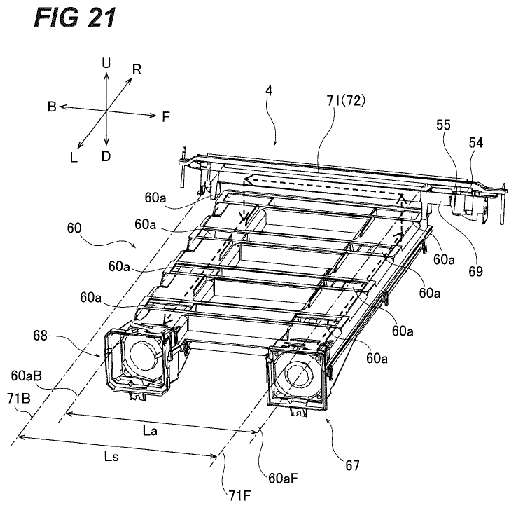

FIG. 17A is a diagram illustrating lengths of the sheet and the opening of the exposure head in the longitudinal direction according to the first embodiment. FIG. 17B is a top view of the exposure head according to the first embodiment. FIG. 18A is a cross-sectional view of the exposure head according to the first embodiment, and is a cross-sectional view of the exposure head taken along line X-X in FIG. 17B. FIG. 18B is a cross-sectional view of the exposure head according to the first embodiment, and is a cross-sectional view of the exposure head taken along line X′-X′ in FIG. 17B. FIG. 19 is a cross-sectional view of the exposure head according to the first embodiment, and is a cross-sectional view of the exposure head taken along line Y-Y in FIG. 17B. FIGS. 20A and 20B are partial perspective views of a protrusion of the casing support member and an elastic member according to the first embodiment, and FIG. 21 is a perspective view of the exposure head, the lifting/lowering duct, and the duct unit according to the first embodiment.

In the exposure head 4, temperature rise due to heat generation from the substrate 50 becomes a problem. Therefore, in the exposure head 4, the temperature rise is curbed by causing the air flow to flow in the space covered by the substrate 50, the casing 54, and the casing support member 55. On the other hand, there is a slight gap between the casing 54 and the casing support member 55. Specifically, there is a gap t1 in the left-right direction in FIG. 18A. Further, at the end of the exposure head 4 in the longitudinal direction, there are a gap t2 in the left-right direction and gaps t3 and t4 in the up-down direction in FIG. 18B. These gaps are necessary gaps from the viewpoint of assemblability of the exposure head and component accuracy. From the viewpoint of assemblability, in a case where there is no gap, when the casing 54 and the casing support member 55 are assembled in the up-down direction in FIG. 18A, one or both of the casing 54 and the casing support member 55 are assembled while being deformed. In this case, an optical system such as the substrate 50 and the lens array 52 may be influenced. From the viewpoint of component accuracy, the casing 54 and the casing support member 55 as a whole have an elongated shape in the front-rear direction (axial direction), and a predetermined amount of warpage may occur in the process of component manufacturing. From the above, it can be seen that a predetermined amount of gap is required between the casing 54 and the casing support member 55 in order to absorb dimensional tolerance including warpage of a component and assemble the component without deformation. However, from the viewpoint of the air flow for cooling the exposure head 4, this gap is not desirable, and there is a possibility that toner, fine dust, and the like are scattered due to blowing or suction from the gap.

Therefore, in the present embodiment, the gaps t1 to t4 between the casing 54 and the casing support member 55 configuring the exposure head 4 are sealed by a sealing member 71 in order to reduce scattering of foreign matter such as toner due to outflow of the air flow from the gaps.

### (Sealing Using Sheet Member)

First, sealing of the gap t1 will be described. In the present embodiment, as illustrated in FIG. 18A, the gap t1 between the casing 54 and the casing support member 55 configuring the exposure head 4 is sealed by the sealing member 71. Here, the sealing member 71 that seals the gap t1 is a sheet member. Hereinafter, the sealing member 71 will also be referred to as a sheet member 72.

The sealing member 71 seals the gap t1 between the substrate support portion of the casing 54 and the side wall of the casing support member 55, which face each other on one side and the other side of the substrate 50 in the left-right direction (the arrow direction illustrated in FIG. 18A) orthogonal to the optical axis direction and the axial direction.

As described above, the casing 54 includes the second opening 54b and holds the substrate 50 and the lens array 52. The casing support member 55 is provided integrally with the casing 54 to cover the second opening 54b of the casing 54, and forms a duct (space) for circulating air between the casing 54 and the casing support member 55.

The second opening 54b of the casing 54 is formed between the extending portions 54R and 54L that are substrate support portions that support one side and the other side of the substrate 50 in the left-right direction. The casing support member 55 includes the right side wall 55R facing the extending portion 54R on one side of the casing in the left-right direction, and the left side wall 55L facing the extending portion 54L on the other side of the casing 54 and facing the right side wall 55R with the casing 54 interposed therebetween.

The sealing member 71 seals the gap t1 between the extending portion 54R on one side and the right side wall 55R and the gap t1 between the extending portion 54L on the other side and the left side wall 55L facing each other in the left-right direction over the axial direction (front-rear direction). As a result, the sealing member 71 can prevent the air flow from flowing out from the two gaps t1 in the left-right direction of the casing 54 and the casing support member 55 illustrated in FIG. 18A, and can reduce scattering of foreign matter such as toner due to outflow of the air flow.

The sealing member 71 is longer than a length from one end 55aF to the other end 55aB of a region where the plurality of openings 55a of the casing support member 55 is provided in the axial direction (see FIGS. 8 and 17A). A range from one end 55aF to the other end 55aB, which is a region provided with the plurality of openings 55a, is the same as the range La of the opening of the lifting/lowering duct 69 illustrated in FIG. 13. That is, a length Ls from one end 71F to the other end 71B of the sealing member 71 in the axial direction is larger than the range La from the one end 55aF to the other end 55aB, which is the region where the plurality of openings 55a of the exposure head 4 is provided.

In other words, as illustrated in FIG. 21, it can be said that the length Ls of the sealing member 71 in the axial direction is larger than the range La that is the region where the opening 60a of the duct unit 60 is provided. As described above, the opening of the lifting/lowering duct 69 also communicates with the opening 60a of the duct unit 60, and a range from the one end 60aF to the other end 60aB, which is the region where the opening 60a of the duct unit 60 is provided, is the same as the range La of the opening of the lifting/lowering duct 69 illustrated in FIG. 13. Therefore, it can also be said that the length Ls from the one end 71F to the other end 71B of the sealing member 71 in the axial direction is larger than the range La from the one end 60aF to the other end 60aB, which is the region where the opening 60a of the duct unit 60 is provided.

Further, one side of the sheet member 72 in the left-right direction is stuck and held to the casing support member 55, the other side is bent toward between the casing 54 and the casing support member 55 and inserted into the gap t1, and the sheet member abuts on the casing 54 by a reaction force when bent.

As illustrated in FIG. 18A, the sheet member 72 is bent from a sticking portion 56 of the casing support member 55 and abuts on the casing 54. By bending the sheet member 72, the casing 54 abutting on the sheet member 72 continues to receive the reaction force of the sheet member 72. With this configuration, the outflow of the air flow due to deflection, waviness, or the like of the sheet member 72 is reduced, and the sheet member 72 and the casing 54 reliably abut on each other in the gap t1.

When the thickness of the sheet member 72 is small, there is a possibility that deflection, waviness, or the like may occur in a case where the sheet member is bent. On the other hand, when the thickness of the sheet member 72 is large, the reaction force continuously received by the casing 54 may increase, and influence the optical system such as the substrate 50 or the lens array 52 held by the casing 54. Therefore, it is necessary to select an appropriate thickness for the sheet member 72.

In the present embodiment, a polyester film having a thickness of 100 μm or less is used for the sheet member 72. For example, Lumirror S10, which is a polyester film manufactured by Toray Industries, Inc. is used as the sheet member 72, and has a thickness of 38 μm.

Although it has been described that the sheet member 72 is bent and inserted into the gap t1 and abuts on the casing 54, the sheet member 72 may abut on both the casing 54 and the casing support member 55.

In addition, the casing support member 55 includes a sticking portion 56 that sticks the sheet member 72 to a surface opposite to a surface facing the casing 54 in the left-right direction. The sticking portions 56 are respectively provided on outer surfaces of the right side wall 55R and the left side wall 55L of the casing support member 55. The sticking portion 56 has a recessed shape (step shape) toward the casing side in the left-right direction compared with a portion of the casing support member 55 adjacent to the sticking portion 56. The sticking portion 56, which is the recess, is a recess thicker than the sheet member 72 in the left-right direction. Therefore, even when the sheet member 72 is stuck to the sticking portion 56 of each side wall of the casing support member 55, the sheet member 72 does not protrude outward from a portion adjacent to the sticking portion 56. As a result, when the exposure head 4 is moved to the exposure position or the retraction position, the sheet member 72 is prevented from being caught around the exposure head 4 to be turned off or peeled off.

### (Sealing Using Elastic Member)

Next, sealing of the gaps t2 to t4 will be described. In the present embodiment, as illustrated in FIG. 18B, the gaps t2 to t4 between the casing 54 and the casing support member 55 configuring the exposure head 4 are sealed by a sealing member 71. Here, the sealing member 71 that seals the gaps t2 to t4 is an elastic member. Hereinafter, the sealing member 71 will also be referred to as an elastic member 73.

The casing support member 55 includes protrusion 55b, such as a rib, that separates a duct (space) formed between the casing 54 and casing support member 55 into a duct portion forming a flow path of an air flow from one side to the other side in the longitudinal direction of the substrate 50 and a non-duct portion located further toward one side in the longitudinal direction than the duct portion.

Here, the duct portion is a region located further toward the rear direction B side in the longitudinal direction than the protrusion 55b with the protrusion 55b as a boundary, and is, for example, a region La illustrated in FIG. 19. The non-duct portion is a region located further toward the front direction F side in the longitudinal direction than the protrusion 55b with the protrusion 55b as a boundary, and is, for example, a region Lc located further toward one side in the longitudinal direction than the region La illustrated in FIG. 17A.

The casing support member 55 includes a guide portion (the right side wall 55R and the left side wall 55L) that guides the air flow from the outside to the inside of the casing support member 55 through the opening 55a in a direction from one side to the other side in the longitudinal direction inside the casing support member 55. The protrusion 55b is provided between the right side wall 55R and the left side wall 55L of the casing support member 55. The protrusion 55b is provided in a portion (bottom surface portion 55D) of the casing support member 55 facing the back surface of the substrate 50, and is provided upstream of the opening 55a.

Further, as illustrated in FIGS. 18B and 19, the exposure head 4 includes an elastic member 73 as the sealing member 71 that seals a gap between the duct portion and the non-duct portion.

The elastic member 73 is an elastic body having a rigidity lower than that of the protrusion 55b of the casing support member 55. The elastic member 73 is, for example, a foamed sealing material.

The elastic member 73 seals the gap t2 between the back surface of the substrate 50 and the protrusion 55b between the duct portion and the non-duct portion.

The elastic member 73 seals the gap t2 between the protrusion 55b and the substrate support portion that supports one side and the other side in the lateral direction orthogonal to the longitudinal direction of the substrate 50 between the duct portion and the non-duct portion.

The elastic member 73 seals the gap t4 between the casing support member 55 and the substrate support portion that supports one side and the other side in the lateral direction orthogonal to the longitudinal direction of the substrate 50 between the duct portion and the non-duct portion.

In the present embodiment, the elastic member 73 is adhesively fixed to the protrusion 55b of the casing support member 55 via a double-sided tape (not illustrated). As illustrated in FIGS. 18A and 18B, when the casing 54 that holds the substrate 50 and the casing support member 55 are assembled, the elastic member 73 comes into contact with the casing 54 and the substrate 50 and is elastically deformed, so that the above-described gaps t2 to t4 can be sealed. As the elastic member 73, in order to reduce physical stress on the substrate 50, the lens array 52, and the casing 54, an EPT sealer of Nitto Denko Corporation which is a sealing material is used.

As illustrated in FIG. 19, by providing the elastic member 73 on the upstream side of the cooling air flow in the exposure head 4, it is possible to more efficiently curb scattering of toner, fine pieces of dust, and the like due to blowing out from the gaps t2 and t3 between the duct portion and the non-duct portion. This is because the air flow generated by the duct unit 60 flows into the exposure head 4 from the upstream opening 55a of the casing support member 55, and the vicinity of the upstream opening 55a dammed by the substrate 50 has a relatively high pressure.

Since the vicinity of the opening 55a on the downstream side of the cooling air flow in the exposure head 4 is forced to be exhausted by the fan 68, there is a low possibility that an unintended air flow is blown out from the gap between the casing 54 and the casing support member 55. However, in order to further reduce the unintended air flow, the elastic member 73 may also be provided on the downstream side of the casing support member 55.

In addition, the configuration has been exemplified in which the casing support member 55 has the protrusion 55b that separates the duct (space) formed between the casing 54 and the casing support member 55 into the duct portion and the non-duct portion, but the present invention is not limited thereto, and the above-described protrusion need not be provided. For example, the elastic member 73 may be provided to separate the duct (space) formed between the casing 54 and the casing support member 55 into the duct portion and the non-duct portion, and the gaps t2 and t3 between the duct portion and the non-duct portion may be sealed by the elastic member 73.

### (Positioning of Exposure Head)

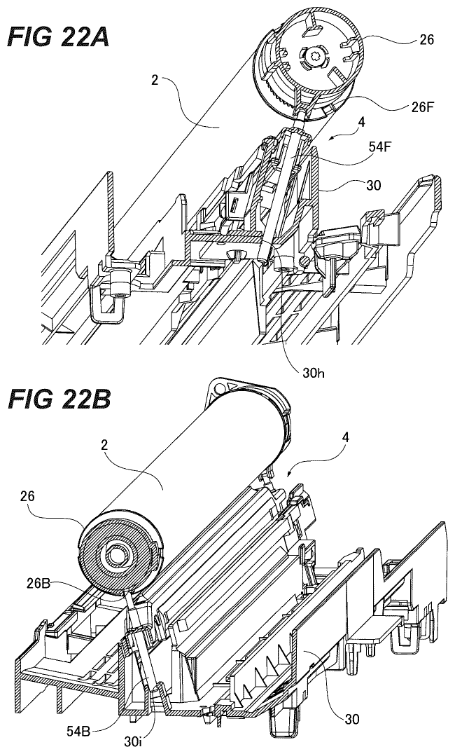

Next, positioning of the exposure head 4 will be described with reference to FIGS. 22A and 22B. FIG. 22A is a perspective view viewed from a front surface cut in a direction orthogonal to the axial direction of the photoconductive drum 2 at the center position of the positioning pins 54F and 54B. FIG. 22B is a perspective view viewed from a rear surface cut in a direction orthogonal to the axial direction of the photoconductive drum 2 at the center position of the positioning pins 54F and 54B.

### (Positioning Pin of Exposure Head)

First, positioning pins 54F and 54B of the exposure head 4 will be described.

The casing 54 of the exposure head 4 is provided with the positioning pin 54F and the positioning pin 54B as positioning shafts. Each of the positioning pin 54F and the positioning pin 54B is an example of a metal pin. The casing 54 is a conductive member having conductivity, and the positioning pins 54F and 54B are also members having conductivity. The positioning pin 54F and the positioning pin 54B are respectively fixed to both ends of the casing 54 in the longitudinal direction. The positioning pin 54F is fixed to the casing 54 further toward one side (front side) than the lens array 52 in the axial direction of the photoconductive drum 2, and protrudes from both sides of the casing 54 in the optical axis direction of the lens array 52. The positioning pin 54B is fixed to the casing 54 further toward the other side (rear side) than the lens array 52 in the axial direction of the photoconductive drum 2, and protrudes from both sides of the casing 54 in the optical axis direction of the lens array 52.

In order to ensure a distance between the surface of the photoconductive drum 2 and the light emission surface of the lens array 52 of the exposure head 4 with high accuracy, the positioning pins 54F and 54B adjust a position of the positioning surface at the shaft tip with reference to the casing 54 and are caulked to the casing 54. Note that the fixing of the positioning pins 54F and 54B to the casing 54 is not limited thereto, and for example, the positioning pin 54F and the positioning pin 54B made of a metal may be fixed to the casing 54 made of a metal through welding. In this manner, the positioning pin 54F and the positioning pin 54B are integrated with the casing 54.

The positioning pin 54F and the positioning pin 54B of the exposure head 4 butt against a drum bearing 26 of the drum unit 23. Specifically, in FIG. 22A, the positioning pin 54F on the front side of the exposure head 4 and the drum bearing 26 on the front side of the photoconductive drum 2 butt against an end surface of the positioning pin 54F. In FIG. 22B, the positioning pin 54B on the rear side of the exposure head 4 and the drum bearing 26 on the rear side of the photoconductive drum 2 butt against an end surface of the positioning pin 54B. As a result, a distance (gap) between the exposure head 4 and the photoconductive drum 2 is determined in a direction orthogonal to the axial direction of the photoconductive drum 2, and a position of the exposure head 4 in the optical axis direction with respect to the photoconductive drum 2 is determined.

The exposure head 4 is fixed not only for a distance to the photoconductive drum 2 but also for an angle by the positioning pins 54F and 54B. In the image forming apparatus 100, the exposure head 4 is disposed toward the center of the photoconductive drum 2. This disposition is adopted because it is not necessary to consider the influence of regular reflection on the surface of the photoconductive drum 2 in the mechanism of the LED (light emitting element) 51 included in the exposure head 4.

Further, in each drum bearing 26 of the photoconductive drum 2, recessed engagement portions 26F and 26B are integrally formed at positions facing the positioning pins 54F and 54B to be engageable with the tips of the positioning pins 54F and 54B. By processing the diameter dimension of the tips of the positioning pins 54F and 54B and the width dimension of the recessed shape of the drum bearing 26 with high accuracy, positioning in the direction orthogonal to the optical axis direction of the exposure head 4 and the direction orthogonal to the axial direction of the photoconductive drum 2 is performed with high accuracy. In addition, inclined surfaces are formed at inlets of the positioning pins 54F and 54B such that the positioning pins 54F and 54B do not ride on the recessed edges when the positioning pins 54F and 54B are engaged with the engagement portions 26F and 26B of the drum bearing 26.

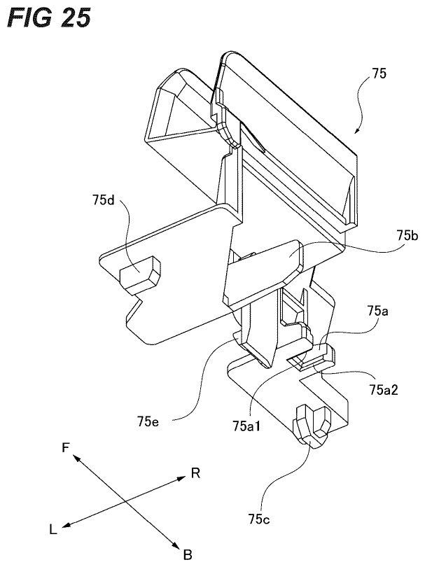

The positioning pins 54F and 54B and the drum bearing 26 are not in contact with each other in the axial direction of the photoconductive drum 2, and are positioned by a recessed restriction portion 75a (see FIG. 25) provided in the positioning member 75.

Here, the drum bearing 26 is a bearing member that axially supports front and rear ends (both ends) of the photoconductive drum. The photoconductive drum 2 is axially supported by the drum bearing 26 without a gap by increasing the dimensional accuracy at the engagement location of the drum bearing 26. That is, positioning with high accuracy on the drum bearing 26 can be regarded as positioning with high accuracy on the photoconductive drum 2. The photoconductive drum 2 is rotationally driven according to the image forming process. Thus, the positioning pins 54F and 54B of the exposure head 4 are positioned with respect to the drum bearing 26.

That is, the positioning pin 54F of the exposure head 4 is positioned with high accuracy with respect to the drum bearing 26 on the front side of the image forming apparatus, and the positioning pin 54B of the exposure head 4 is also positioned with high accuracy with respect to the drum bearing 26 on the rear side of the image forming apparatus. Therefore, the exposure head 4 is positioned with high accuracy at both ends of the photoconductive drum 2 in the axial direction.

Furthermore, as illustrated in FIGS. 22A and 22B, the lower end peripheral surfaces of the positioning pins 54F and 54B are supplementarily fitted to auxiliary fitting portions 30h and 30i of the cartridge tray 30 in the direction orthogonal to the optical axis direction of the exposure head 4 and the direction orthogonal to the axial direction of the photoconductive drum 2. As a result, even when a slight rotational moment is generated due to the weight, surface property, dimensional error, and the like of a component, stable positioning accuracy at a distance and an angle, and repeated attachment and detachment operations can be realized.

### (Positioning Member of Exposure Head)

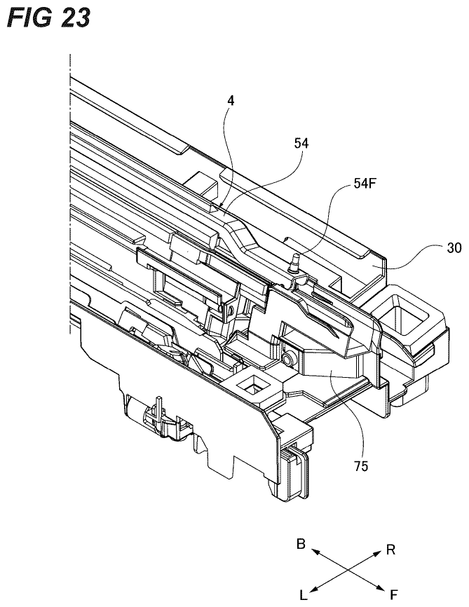

Next, positioning of the exposure head 4 in the axial direction of the photoconductive drum 2 using the positioning member 75 will be described with reference to FIGS. 23 to 25.

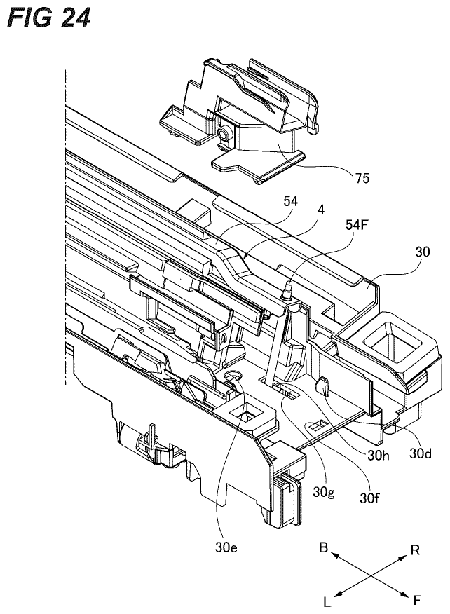

FIG. 23 is a perspective view of the positioning member 75 after attachment, and FIG. 24 is a perspective view of the positioning member 75 before attachment. FIG. 25 is a perspective view illustrating a shape of the positioning member 75.

As illustrated in FIG. 23, the positioning member 75 for positioning the exposure head 4 with respect to the image forming apparatus 100 is attached to the front side of the exposure head 4. As illustrated in FIG. 24, a biasing portion 30d, a round hole 30e, a square hole 30f, and a projection engagement portion 30g are provided on the front side of the cartridge tray 30.

As illustrated in FIG. 25, the lower surface of the positioning member 75 is provided with a head restriction portion 75a, a biasing portion 75b, a cross protrusion portion 75c, an I-shaped protrusion portion 75d, and a projection portion 75e.

The outer diameter of the cross protrusion portion 75c is substantially equal to the inner diameter of the round hole 30e, and the length of the I-shaped protrusion portion 75d in the left-right direction is substantially equal to the length of the square hole 30f in the left-right direction. By fitting the protrusion portions 75c and 75d to the holes 30e and 30f, the positions of the positioning member 75 in the front-rear direction and the left-right direction are determined.

The projection portion 75e has a barbed shape, and the barbed shape is caught by the projection engagement portion 30g, whereby the position of the positioning member 75 in the up-down direction is determined.

The positioning member 75 is engaged with the cartridge tray 30 as described above, and is thus positioned in the front-rear direction, the left-right direction, and the up-down direction with respect to the cartridge tray 30.

The head restriction portion 75a has a first abutment surface 75al abutting on one side of the positioning pin 54F in the axial direction and a second abutment surface 75a2 abutting on the other side of the positioning pin 54F in the axial direction. The first abutment surface 75al and the second abutment surface 75a2 face each other in the axial direction. The head restriction portion 75a has a recessed shape in which the right side in the left-right direction is open, and the notch width of the recessed shape in the front-rear direction and the outer diameter of the positioning pin 54F are configured to be substantially equal. By fitting the head restriction portion 75a and the positioning pin 54F, the position of the exposure head 4 in the axial direction of the photoconductive drum 2 is determined with respect to the positioning member 75.

As described above, the position of the exposure head 4 in the axial direction of the photoconductive drum 2 can be accurately determined by the positioning member 75 attached after the attachment of the exposure head 4.

In the present embodiment, backlash is reduced by the biasing portion 75b and the biasing portion 30d. The biasing portion 75b extends rightward in the left-right direction from the positioning member 75, has a small thickness in the axial direction of the photoconductive drum 2, and has a shape that is easily elastically deformed in the axial direction of the photoconductive drum 2. On the other hand, the biasing portion 30d has a shape protruding from the upper surface of the cartridge tray 30, and is formed in a shape having a rigidity so as not to be deformed in the axial direction of the photoconductive drum 2. When the positioning member 75 is attached to the cartridge tray 30, the tip of the biasing portion 75b has a dimensional relationship of interfering with (coming into contact with) the biasing portion 30d. The front surface of the tip of the biasing portion 75b and the back surface of the biasing portion 30d come into contact with each other, and the biasing portion 75b is elastically deformed in the back surface direction, so that the positioning member 75 is biased in the back surface direction, that is, from one side to the other side in the axial direction of the photoconductive drum 2 by the reaction force.

In other words, the image forming apparatus 100 includes the biasing portion 30d as a biasing member that applies a force to the exposure head 4 in the longitudinal direction. Here, the configuration in which the cartridge tray 30, which is a support member that supports the photoconductive drum 2, includes the biasing portion 30d that applies a force to the positioning member 75 from one side to the other side in the axial direction as the biasing member has been exemplified. That is, in the present embodiment, the biasing portion 75b of the positioning member 75 is biased in the axial direction of the photoconductive drum 2 by the biasing portion 30d of the cartridge tray 30. However, any configuration may be adopted as long as the exposure head 4 is biased in the longitudinal direction.

By adopting the configuration in which the positioning member 75 is biased in the axial direction of the photoconductive drum 2 as described above, it is possible to realize highly accurate positioning of the exposure head 4 which is hardly affected by repeated operations of attaching and detaching the exposure head 4 and to realize more precise positioning.

### (Cleaning Rod and Guide Configuration of Cleaning Rod)

The image forming apparatus 100 includes a longitudinal-shaped cleaning rod 81 that is inserted from the outside of the image forming apparatus 100 and rubs and cleans the light emission surface 52a of the lens array 52 in the longitudinal direction. In addition, the image forming apparatus 100 includes a first guide member 91 and a second guide member 92 that guide the cleaning rod 81 inserted from the outside of the image forming apparatus 100.

### (Configuration of Cleaning Rod)

Next, a configuration of the cleaning rod 81 will be described.

In the image forming apparatus 100, the exposure head 4 is provided between the charging roller 3 of the drum unit 23 and the development unit 24. When toner or the like is attached to the light emission surface of the lens array 52 included in the exposure head 4, there is a possibility that the attached substance partially shields the light emitted from the light emitting element, which causes a decrease in the image quality of an output image. Therefore, the light emission surface 52a of the exposure head 4 is desirably cleaned periodically.

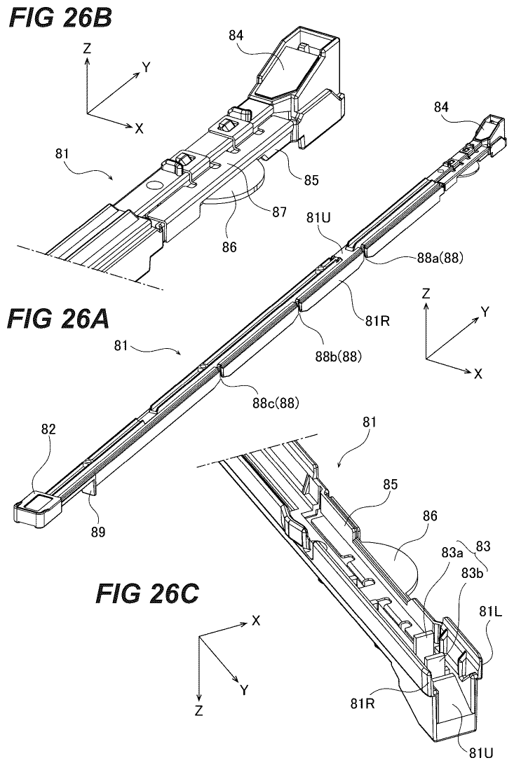

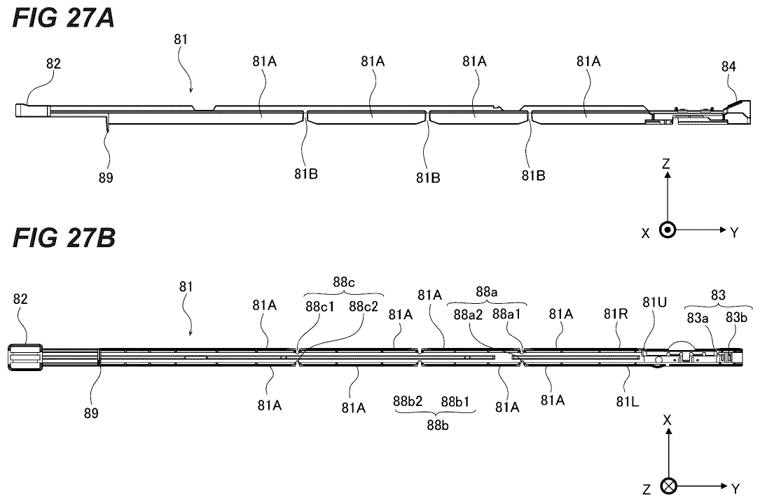

The image forming apparatus 100 includes the cleaning rod 81 for cleaning the lens array 52 of the exposure head 4. A configuration of the cleaning rod 81 will be described with reference to FIGS. 26A to 26C and FIGS. 27A and 27B.

FIGS. 26A to 26C and FIGS. 27A and 27B are diagrams illustrating a configuration of the cleaning rod 81. FIG. 26A is a schematic perspective view of the cleaning rod 81 for cleaning a surface (light emission surface) of the lens array 52 of the exposure head 4. FIG. 26B is a view illustrating one end side (tip side) of the cleaning rod 81 in the longitudinal direction. FIG. 26C is a view of the tip side of the cleaning rod 81 as viewed from below. FIG. 27A is a side view of the cleaning rod 81. FIG. 27B is a bottom view of the cleaning rod 81.

Here, the longitudinal direction of the exposure head 4 is a direction along the rotational axis direction of the photoconductive drum 2 and is a direction parallel to the rotational axis direction. One side of the exposure head 4 in the longitudinal direction is the front side in the front-rear direction, and the other side in the longitudinal direction is the rear side in the front-rear direction. A width direction (lateral direction) orthogonal to the longitudinal direction of the exposure head 4 is defined as a first direction. An optical axis direction orthogonal to both a longitudinal direction of the exposure head 4 and a width direction (first direction) orthogonal to the longitudinal direction is defined as a second direction. The defined longitudinal direction Y, width direction (first direction) X, and optical axis direction (second direction) Z are illustrated in FIGS. 26A to 26C and FIGS. 27A and 27 B, and the like.

In addition, during a cleaning operation, the longitudinal direction of the cleaning rod 81 is the same as the Y direction, the lateral direction of the cleaning rod 81 is the same as the X direction, and the insertion/removal direction of the cleaning rod 81 is the same as the Y direction.

The cleaning rod 81 cleans the lens array 52 of the exposure head 4. The cleaning rod 81 has an elongated rod shape as a whole, and has a shape extending in the longitudinal direction along the rotational axis direction of the photoconductive drum 2. The cleaning rod 81 includes a cleaning member 83, a grip portion 82, a protruding portion 86, an elastic portion 85, a guide member 87, a notch portion 88, and a wall 89.

The grip portion 82 is provided at the other end (rear end) of the cleaning rod 81 in the longitudinal direction, and is a portion gripped by an operator at the time of cleaning.

The cleaning member 83 is provided at one end (tip) of the cleaning rod 81 in the longitudinal direction, and abuts on the light emission surface 52a of the lens array 52 to clean off attached matter such as toner attached to the light emission surface 52a of the lens array 52. The cleaning member 83 is provided on a lower side of the cleaning rod 81. The cleaning rod 81 moves the cleaning member 83 in the longitudinal direction to clean the lens array 52.

Here, the cleaning member 83 includes two cleaning members 83a and 83b. The cleaning members 83a and 83b are disposed at different positions in the longitudinal direction of the exposure head 4. The cleaning members 83a and 83b are disposed at different positions in the optical axis direction of the light emission surface of the exposure head 4. More specifically, the tips of the cleaning members 83a and 83b are disposed at different positions in the optical axis direction with respect to the light emission surface 52a of the exposure head 4. The number and disposition of the cleaning members 83 are not limited thereto, and for example, three or more cleaning members 83 may be disposed.

A pressing member 84 for fixing the cleaning member 83 is provided at the tip of the cleaning rod 81 in the longitudinal direction.

The cleaning rod 81 is provided with the elastic portion 85. Here, the elastic portion 85 is provided on one side in the width direction of the cleaning rod 81. In the elastic portion 85, the rigidity in the first direction (the width direction or the X direction) is different from the rigidity in the second direction (the optical axis direction or the z direction), and the rigidity in the width direction is lower than the rigidity in the optical axis direction. Specifically, the cross section of the elastic portion 85 viewed from the longitudinal direction is rectangular, and the thickness in the first direction (X direction) is smaller than the thickness in the second direction (Z direction). With this configuration, the rigidity of the elastic portion 85 in the width direction is lower than the rigidity in the optical axis direction.

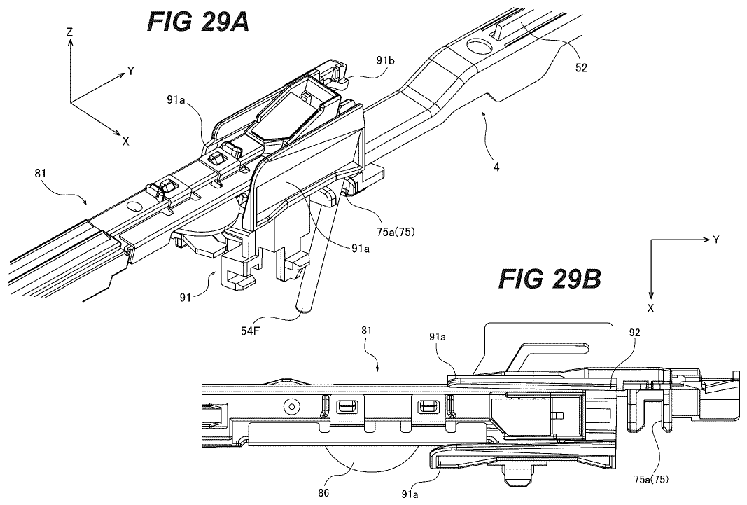

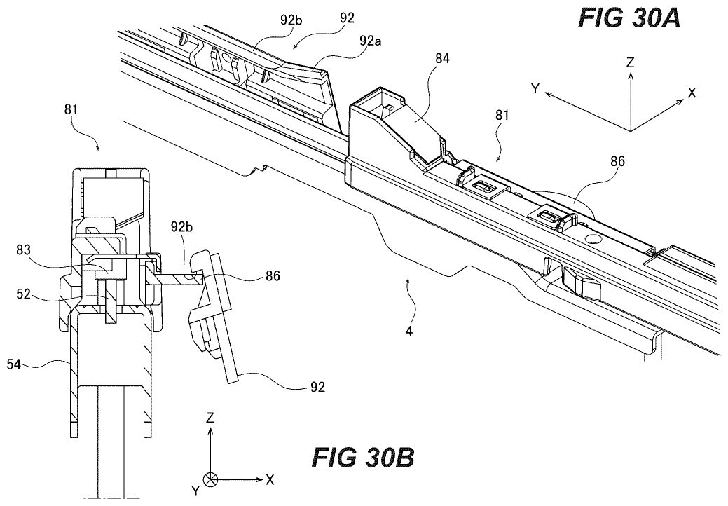

The cleaning rod 81 is provided with the protruding portion 86 protruding to one side in the width direction. The protruding portion 86 protrudes more outward in the width direction than a first guide member 91 (see FIG. 29B) and is provided at a position where the protruding portion can abut on a second guide member 92 (see FIG. 30B). The protruding portion 86 is provided to be movable between a position protruding more outward in the width direction than the first guide member 91 and a position retracted more inward in the width direction of the first guide member 91 than the protruding position. The protruding portion 86 is guided by the second guide member 92 at the protruding position.

The protruding portion 86 is provided in the elastic portion 85, and moves in the width direction when the elastic portion 85 is elastically deformed in the width direction. In other words, the protruding portion 86 is provided to be movable in the width direction.

The protruding portion 86 is provided in the vicinity of the cleaning member 83. Here, the protruding portion 86 is provided immediately after the cleaning member 83 in the longitudinal direction in the insertion direction of the cleaning rod 81 (the longitudinal direction or the Y direction).

Further, the cleaning rod 81 includes the guide member 87 that restricts a position of the elastic portion 85 in the optical axis direction (second direction). The guide member 87 restricts deformation of the elastic portion 85 due to an unexpected external force in the optical axis direction within a predetermined range. The guide member 87 is made of a metal material, and is formed of, for example, a sheet metal made of a metal material.

The cleaning rod 81 has a cross-sectional shape including a facing portion 81U facing the light emission surface 52a of the lens array 52 and wall portions 81R and 81L extending from both sides in a lateral direction orthogonal to the longitudinal direction of the facing portion 81U toward the exposure head side. The facing portion 81U supports the cleaning member 83 (83a, 83b). The wall portions 81R and 81L are engaged with the exposure head 4 over the longitudinal direction of the cleaning rod 81.

The cleaning rod 81 includes a first portion 81A whose cross-sectional shape in a direction orthogonal to the longitudinal direction (Y direction) of the cleaning rod 81 is a first cross-sectional shape, and a second portion 81B having a second cross-sectional shape different from the first cross-sectional shape of the first portion 81A.

The second portion 81B is provided at a position different from a position of the first portion 81A in the longitudinal direction.

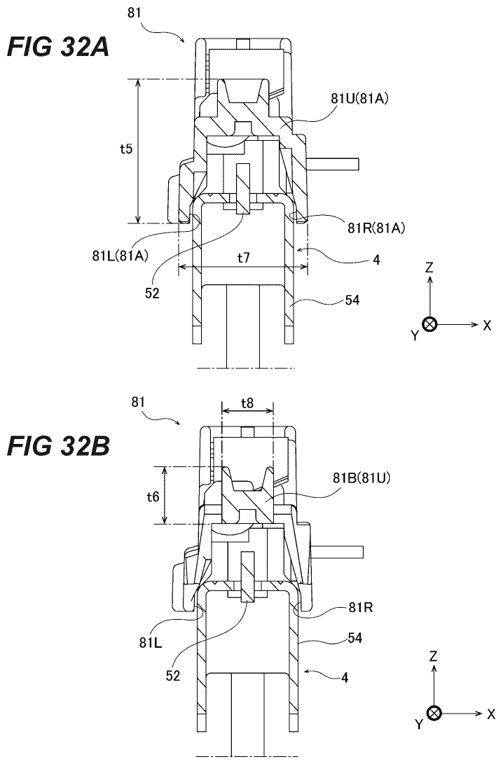

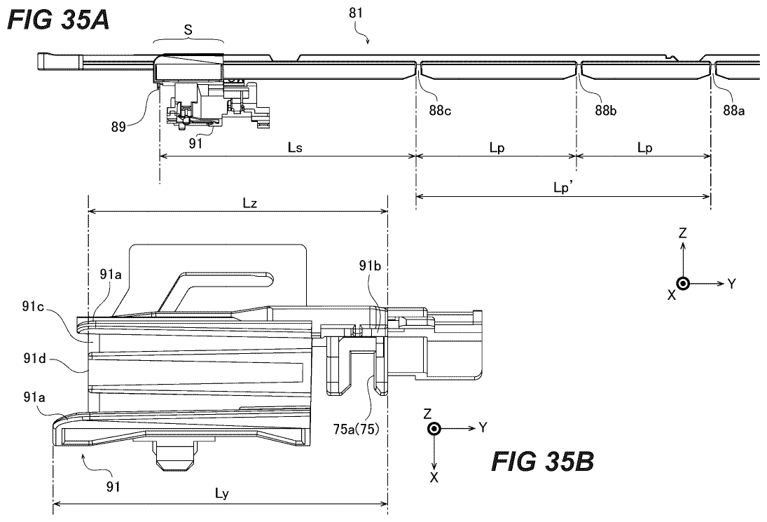

The first cross-sectional shape of the first portion 81A of the cleaning rod 81 and the second cross-sectional shape of the second portion 81B of the cleaning rod 81 are different as follows. This will be described with reference to FIGS. 32A and 32B and FIGS. 35A and 35B. FIGS. 32A and 32B are diagrams illustrating a shape of a notch portion according to the first embodiment. FIGS. 35A and 35B are diagrams illustrating a length relationship of each portion of the cleaning rod 81 and the first guide member 91 according to the first embodiment.

The second cross-sectional shape of the second portion 81B of the cleaning rod 81 is smaller in area than the first cross-sectional shape of the first portion 81A of the cleaning rod 81. The second cross-sectional shape of the second portion 81B of the cleaning rod 81 is illustrated in FIG. 32B. The first cross-sectional shape of the first portion 81A of the cleaning rod 81 is illustrated in FIG. 32A.

The second cross-sectional shape of the second portion 81B of the cleaning rod 81 has a smaller width in the optical axis direction (Z direction) along the optical axis of the lens array 52 than the first cross-sectional shape of the first portion 81A of the cleaning rod 81 (t6<t5). A width t6 of the second cross-sectional shape of the second portion 81B of the cleaning rod 81 in the optical axis direction is illustrated in FIG. 32B. A width t5 of the first cross-sectional shape of the first portion 81A of the cleaning rod 81 in the optical axis direction is illustrated in FIG. 32A.

The second cross-sectional shape of the second portion 81B of the cleaning rod 81 has a smaller width in the lateral direction (X direction) orthogonal to the longitudinal direction (Y direction) of the cleaning rod 81 than the first cross-sectional shape of the first portion 81A of the cleaning rod 81 (t8<t7). A width t8 in the lateral direction of the second cross-sectional shape of the second portion 81B of the cleaning rod 81 is illustrated in FIG. 32B. A width t7 in the lateral direction of the first cross-sectional shape of the first portion 81A of the cleaning rod 81 is illustrated in FIG. 32A.

The cleaning rod 81 has a plurality of the second portions 81B in the longitudinal direction (Y direction). Here, a configuration in which the cleaning rod 81 has second portions 81B at three locations in the longitudinal direction is exemplified, but the present invention is not limited thereto.

As illustrated in FIG. 35A, the first guide member 91 that guides the cleaning rod 81 in the longitudinal direction (Y direction) has a length S in the longitudinal direction (Y direction). On the other hand, the first portion 81A of the cleaning rod 81 has a U-shaped cross-sectional shape including the facing portion 81U and the wall portions 81R and 81L on both sides thereof (see FIG. 32A). As illustrated in FIG. 35A, in the first portion 81A of the cleaning rod 81, lengths Ls and Lp in the longitudinal direction (Y direction) are larger than the length S of the first guide member 91 in the longitudinal direction.

As illustrated in FIGS. 27A and 27B, the wall portions 81R and 81L of the cleaning rod 81 are provided with notch portions 88. In the cleaning rod 81, a portion provided with the notch portion 88 corresponds to the second portion 81B. The notch portion 88 has a shape in which a part of the wall portions 81R and 81L is thinned in the optical axis direction (Z direction) and the lateral direction (X direction) of the cleaning rod 81. In other words, the second portion 81B of the cleaning rod 81 has a cross-sectional shape in which the wall portions 81R and 81L engaged with the exposure head 4 are shorter than the first portion 81A.

As a result, the second portion 81B of the cleaning rod 81 has a smaller geometrical moment of inertia in the optical axis direction and the lateral direction than the first portion 81A of the cleaning rod 81. Specifically, the geometrical moment of inertia of the cleaning rod 81 in the notch portion 88 is 70% or less of the geometrical moment of inertia of the cleaning rod 81 in a portion other than the notch portion 88. Therefore, by providing the notch portion 88, the cleaning rod 81 has a shape having a low rigidity in the optical axis direction and the lateral direction of the cleaning rod 81.

Note that, in the present embodiment, the geometrical moment of inertia in the optical axis direction and the lateral direction is reduced by the notch portion 88, but the geometrical moment of inertia may be reduced only in one of the directions. Therefore, the cleaning rod 81 has the notch portion 88 such that the geometrical moment of inertia decreases in the direction orthogonal to the longitudinal direction (Y direction) of the cleaning rod 81.

As illustrated in FIG. 27B, the notch portions 88 include six notch portions 88a1, 88a2, 88b1, 88b2, 88c1, and 88c2. The notch portion 88al and the notch portion 88a2 are disposed at the same position in the longitudinal direction (Y direction) of the cleaning rod 81, and are disposed to face each other in the lateral direction (X direction) of the cleaning rod 81. The notch portion 88b1 and the notch portion 88b2 are disposed at the same position in the longitudinal direction of the cleaning rod 81, and are disposed to face each other in the lateral direction of the cleaning rod 81. The notch portion 88cl and the notch portion 88c2 are disposed at the same position in the longitudinal direction of the cleaning rod 81, and are disposed to face each other in the lateral direction of the cleaning rod 81. Therefore, the cleaning rod 81 has two sets of the notch portions 88a, 88b, and 88c facing each other in the lateral direction.

In addition, the cleaning rod 81 has two or more sets of the notch portions 88 facing each other in the lateral direction in the longitudinal direction of the cleaning rod 81. Note that, in the present embodiment, the six notch portions 88a1, 88a2, 88b1, 88b2, 88c1, and 88c2 are disposed in the notch portion 88, but the number of notch portions is not limited thereto, and five or less or seven or more notch portions may be disposed. In the present embodiment, the two notch portions are disposed to face each other in the lateral direction of the cleaning rod 81, but the present invention is not limited to such disposition, and the two notch portions may be disposed to be shifted in the longitudinal direction of the cleaning rod 81.

The cleaning rod 81 has a wall 89 on the other end side (rear end side) in the longitudinal direction. In the cleaning operation for the exposure head 4 using the cleaning rod 81, the wall 89 abuts on the first guide member 91 to restrict the position of the cleaning rod 81 in the insertion direction (Y direction). The wall 89 is a stopper for restricting an entry amount of the cleaning rod 81 in the longitudinal direction so that the cleaning rod 81 is not inserted at a predetermined position or more. The notch portion 88 is disposed between the wall 89 and the cleaning member 83 in the longitudinal direction of the cleaning rod 81.

### (Guide Configuration of Cleaning Rod)

Next, a guide configuration of the cleaning rod 81 will be described.

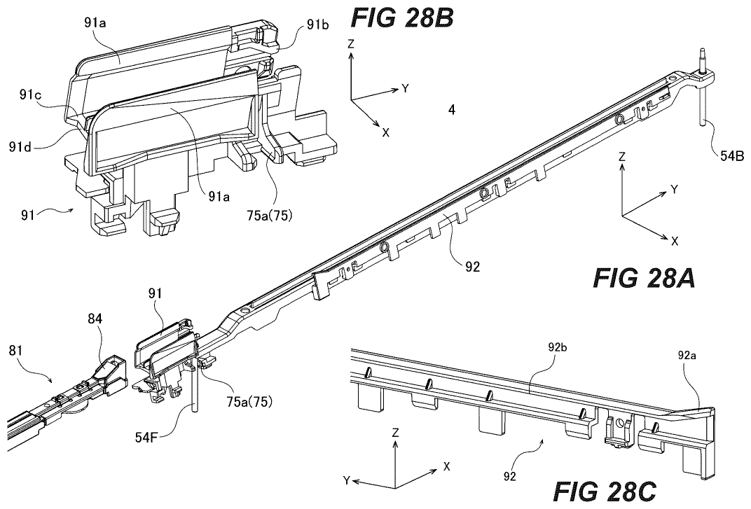

The image forming apparatus 100 includes the first guide member 91 and the second guide member 92 that guide the cleaning rod 81 cleaning the lens array 52 of the exposure head 4. The first guide member 91 and the second guide member 92 will be described with reference to FIGS. 28A to 28C, FIGS. 29A and 29 B, and FIGS. 30A and 30B.

FIGS. 28A to 28C are diagrams illustrating a guide configuration of the cleaning rod according to the first embodiment. FIGS. 29A and 29B are cross-sectional views illustrating a configuration of the first guide member according to the first embodiment. FIGS. 30A and 30B are views illustrating a configuration of the second guide member according to the first embodiment.

The image forming apparatus 100 includes a frame body (not illustrated) as a casing. As illustrated in FIG. 28A, the frame body is provided with the first guide member 91 and the second guide member 92. The first guide member 91 and the second guide member 92 are disposed to be shifted between the front side and the back side of the image forming apparatus 100 in the front-rear direction, and the first guide member 91 is disposed on the front side and the second guide member 92 is disposed on the back side.

The first guide member 91 is provided on an extension line in the longitudinal direction of the lens array 52. The first guide member 91 is provided on the front side in the longitudinal direction of the lens array 52 separately from the exposure head 4. The first guide member 91 guides the cleaning rod 81 between the photoconductive drum 2 and the exposure head 4.

The first guide member 91 includes a cleaning rod restriction portion that restricts a position of the cleaning rod 81. Here, as illustrated in FIG. 28B, the first guide member 91 includes first restriction portions 91a and 91a, a second restriction portion 91b, and a third restriction portion 91c as the cleaning rod restriction portions.

The first guide member 91 includes first restriction portions 91a and 91a that restrict a position of the cleaning rod 81 in the first direction (the lateral direction or the X direction). The first restriction portions 91a and 91a are provided to face each other on both sides in the width direction (X direction) orthogonal to the longitudinal direction. The movement of the cleaning rod 81 in the width direction is restricted between the first restriction portions 91a and 91a provided to face each other on both sides in the width direction.

The first guide member 91 includes the second restriction portion 91b and the third restriction portion 91c that restrict a position of the cleaning rod 81 in the second direction (the optical axis direction or the Z direction). The second restriction portion 91b and the third restriction portion 91c are provided to face each other on both sides in the optical axis direction (Z direction). The movement of the cleaning rod 81 in the optical axis direction is restricted between the second restriction portion 91b and the third restriction portion 91c provided to face each other on both sides in the optical axis direction.

The end of the second restriction portion 91b on the front side in the longitudinal direction is located further toward the back side in the longitudinal direction than the end of the first restriction portion 91a or the third restriction portion 91c on the front side in the longitudinal direction. As a result, operability of inserting the cleaning rod 81 into the first guide member 91 is improved.

The width in the width direction (X direction) of the cleaning rod 81 including the protruding portion 86 is larger than the width in the width direction (X direction) inside the first restriction portions 91a and 91a of the first guide member 91. As described above, the protruding portion 86 is provided in the elastic portion 85 and is movable (elastically deformable) in the width direction. When entering between the first restriction portions 91a and 91a of the first guide member 91, the protruding portion 86 moves to a position retracted more inward in the width direction of the first guide member 91 than a position protruding from the width of the first guide member 91 due to elastic deformation of the elastic portion 85. When passing through the first guide member 91, the protruding portion 86 moves from the retraction position to the protruding position by the restoring force of the elastic portion 85, that is, returns to a position which is the original position where the protruding portion 86 can abut on the second guide member 92.

The first guide member 91 has an abutment portion 91d for stopping the inserted cleaning rod 81 at a predetermined position. As a result, when the cleaning rod 81 is inserted into the first guide member 91, the wall 89 of the cleaning rod 81 abuts on the abutment portion 91d of the first guide member 91, so that the movement of the cleaning rod 81 in the insertion direction is restricted and the cleaning rod 81 is stopped at a predetermined position.

Furthermore, the first guide member 91 includes a head restriction portion 75a that restricts a position of the exposure head 4. The movement of the exposure head 4 in the longitudinal direction (Y direction) of the exposure head 4, which is the insertion direction of the cleaning rod 81, is restricted by the head restriction portion 75a. With this configuration, at the time of cleaning, the movement of the exposure head 4 toward the back side in the insertion direction due to the insertion of the cleaning rod 81 is restricted.

In the present embodiment, the positioning member 75 including the head restriction portion 75a is provided on the first guide member 91. In other words, the first guide member 91 also serves as the positioning member 75 that abuts on the exposure head 4 to determine the position of the exposure head 4 in the longitudinal direction. The first guide member 91 is not limited to the configuration in which the first guide member 91 also serves as the positioning member 75, and the positioning member 75 may be provided separately.

In the present embodiment, as described above, backlash is reduced by the biasing portion 75b (see FIG. 25) and the biasing portion 30d (see FIG. 24). The biasing portion 75b extends rightward in the left-right direction from the positioning member 75, has a small thickness in the axial direction of the photoconductive drum 2, and has a shape that is easily elastically deformed in the axial direction of the photoconductive drum 2. On the other hand, the biasing portion 30d has a shape protruding from the upper surface of the cartridge tray 30, and is formed in a shape having a rigidity so as not to be deformed in the axial direction of the photoconductive drum 2. When the positioning member 75 is attached to the cartridge tray 30, the tip of the biasing portion 75b has a dimensional relationship of interfering with (coming into contact with) the biasing portion 30d. The front surface of the tip of the biasing portion 75b and the back surface of the biasing portion 30d come into contact with each other, and the biasing portion 75b is elastically deformed in the back surface direction, so that the positioning member 75 is biased in the back surface direction, that is, from one side to the other side in the axial direction of the photoconductive drum 2 by the reaction force.

That is, the image forming apparatus 100 includes the biasing portion 30d as a biasing member that applies a force to the exposure head 4 in the longitudinal direction. Here, the cartridge tray 30 which is a support member that supports the photoconductive drum 2 includes the biasing portion 30d that applies a force to the positioning member 75 from one side to the other side in the axial direction. As a result, the first guide member 91 also serving as the positioning member 75 including the biasing portion 75b is applied with a force from one side to the other side in the axial direction by the biasing portion 30d of the cartridge tray 30.

As described above, the second guide member 92 is provided further toward the back side in the longitudinal direction than the first guide member 91. The second guide member 92 is provided separately from the exposure head 4 on the outside of the exposure head 4 in the width direction (first direction) orthogonal to the longitudinal direction. The second guide member 92 guides the cleaning rod 81 guided between the photoconductive drum 2 and the exposure head 4 in the longitudinal direction of the exposure head 4.

As illustrated in FIG. 28C, the second guide member 92 includes the first guide portion (inclined portion) 92a and the second guide portion (restriction portion) 92b. The first guide portion 92a has an inclination that guides the cleaning rod 81 in a direction in which the cleaning member 83 approaches the light emission surface of the lens array 52 in the optical axis direction (Z direction). The first guide portion 92a is provided at the end of the second guide member 92 on the first guide member 91 side.

When the protruding portion 86 of the cleaning rod 81 abuts, the first guide portion 92a guides the cleaning member 83 in a direction of approaching the light emission surface of the lens array 52, and causes the cleaning member 83 to abut on the light emission surface of the lens array 52.

The second guide portion 92b is provided further toward the back side in the longitudinal direction than the first guide portion 92a. The second guide portion 92b is provided in the longitudinal direction along the lens array 52. When the protruding portion 86 of the cleaning rod 81 abuts, the second guide portion 92b restricts a position of the cleaning member 83 in the optical axis direction (Z direction) abutting on the light emission surface of the lens array 52 over the longitudinal direction of the lens array 52.

The first guide portion 92a and the second guide portion 92b are provided outside the exposure head 4 in the width direction, and do not hinder the movement of the exposure head 4 moving to the exposure position and the retraction position in the optical axis direction (Z direction). The protruding portion 86 of the cleaning rod 81 protrudes more outward in the width direction than the exposure head 4 and is provided at a position where the protruding portion can abut on the second guide member 92 (see FIG. 30B). The first guide portion 92a and the second guide portion 92b abut on the protruding portion 86 protruding more outward in the width direction than the exposure head 4 to restrict a position of the cleaning member 83 in the optical axis direction as described above.

### (Cleaning Operation)

Next, an operation when cleaning the exposure head 4 using the cleaning rod 81 will be described.

As described above, the exposure head 4 is movably supported between the exposure position at which the photoconductive drum 2 is exposed and the retraction position farther away from the photoconductive drum 2 than the exposure position. The exposure head 4 is moved between the exposure position and the retraction position in the optical axis direction by the moving mechanism.

Cleaning of the light emission surface of the lens array 52 using the cleaning rod 81 is performed in a state in which the exposure head 4 is moved to a position retracted from the photoconductive drum 2 by the moving mechanism. That is, the retraction position mentioned here means a cleaning position for cleaning the light emission surface of the lens array 52. An operator grips and operates the grip portion 82 provided on the rear end side of the cleaning rod 81 to clean the light emission surface of the lens array 52.

As illustrated in FIG. 26C, the cleaning member 83 is provided on the tip side (the other end side in the rotational axis direction of the photoconductive drum 2) of the cleaning rod 81 and on the lower side. The cleaning member 83 is, for example, an elastically deformable member made of rubber such as sponge or elastomer, and scrapes off and cleans off attached matter such as toner attached to the light emission surface of the lens array 52. In addition, the cleaning member 83 is not limited to an elastically deformable member, and for example, cleaning may be performed by wiping off attached matter such as toner attached to the light emission surface of the lens array 52 using a nonwoven fabric made of fibers such as cotton, nylon, and polyester.

FIG. 29A illustrates a state in which the cleaning rod 81 is inserted into the first guide member 91 provided in the image forming apparatus 100. FIG. 29B is a view for describing the function of the first guide member 91, and is a view as viewed from above the main body. The first guide member 91 is provided further toward the front side of the apparatus body than the exposure head 4. As illustrated in FIG. 29B, the first guide member 91 has the first restriction portions 91a and 91a on both sides in the first direction. The first guide member 91 includes the second restriction portion 91b (see FIG. 28B) and the third restriction portion 91c on both sides in the second direction. When the cleaning rod 81 is inserted between the first restriction portions 91a and 91a of the first guide member 91 by the operator, the protruding portion 86 abuts on one of the first restriction portions 91a while the position of the cleaning rod 81 on the lower side in the second direction is restricted by the third restriction portion 91c. In this case, since the width of the cleaning rod 81 including the protruding portion 86 is larger than the width between the first restriction portions 91a and 91a in the first direction, when the cleaning rod is further inserted, the protruding portion 86 is retracted due to the elastic deformation of the elastic portion 85 in the first direction, and advances while abutting on the first restriction portion 91a. As a result, the operator can insert the cleaning rod 81 while the position of the cleaning rod 81 in the first direction is restricted by the first guide member 91. The position of the cleaning rod 81 on the upper side in the second direction is restricted by the second restriction portion 91b before the tip thereof passes through the first guide member 91. After the tip side of the cleaning rod 81 passes through the first guide member 91, when the restriction (abutment) by the one first restriction portion 91a is released, the protruding portion 86 returns to the position before the elastic deformation by the restoring force of the elastic portion 85 in the first direction. That is, the protruding portion 86 returns to a position where the protruding portion 86 can abut on the first guide portion 92a and the second guide portion 92b of the second guide member 92.

FIG. 30A illustrates a state immediately before the cleaning rod 81 is inserted into the second guide member 92 provided in the image forming apparatus 100. FIG. 30B is a view for describing the function of the second guide member 92, and is a cross-sectional view viewed from the front side of the main body. The second guide member 92 is provided further toward the back side than the first guide member 91. The second guide member 92 is disposed in the longitudinal direction along the exposure head 4. The first guide portion 92a is provided at the end of the second guide member 92 on the first guide member 91 side. As illustrated in FIG. 30A, the first guide portion 92a is inclined downward from the front side which is one end side in the longitudinal direction toward the back side which is the other end side, in order to guide the cleaning rod 81 in a direction in which the cleaning member 83 abuts on the light emission surface of the lens array 52. As a result, when the cleaning rod 81 is inserted into the second guide member 92 by the operator, the protruding portion 86 is guided to advance downward by the first guide portion 92a. Therefore, the operator can more easily insert the cleaning rod 81 into the second guide member 92 without causing the protruding portion 86 to deviate above the second guide member 92. In other words, the cleaning rod 81 can be stably guided with respect to the exposure head 4, and the workability at the time of cleaning is improved. In addition, the cleaning member 83 reliably abuts on the light emission surface of the lens array 52, so that cleaning can be started.

As illustrated in FIG. 30B, the second guide member 92 has a U-shaped cross section, and includes the second guide portion 92b above in the second direction. When the cleaning member 83 cleans the light emission surface of the lens array 52, a repulsive force from the lens array 52 acts on the cleaning member 83, and the tip side of the cleaning rod 81 attempts to uplift in the second direction. In this case, a position of the cleaning rod 81 in the second direction is restricted by the second restriction portion 91b (see FIG. 28B) provided in the first guide member 91. However, since the cleaning rod 81 moves away from the second restriction portion 91b as it is inserted into the back side, the restriction is insufficient only with the second restriction portion 91b.

Therefore, the protruding portion 86 provided in the vicinity of the cleaning member 83 of the cleaning rod 81 abuts on the second guide portion 92b provided in the longitudinal direction along the exposure head 4. When the protruding portion 86 of the cleaning rod 81 abuts on the second guide portion 92b of the second guide member 92, a repulsive force from the lens array 52 can be received, the position of the tip side of the cleaning rod 81 in the second direction is restricted, and uplifting on the back side is prevented. As a result, the cleaning rod 81 can be inserted to the back side without separating the cleaning member 83 of the cleaning rod 81 from the light emission surface of the lens array 52, and the light emission surface of the lens array 52 can be reliably cleaned over the entire longitudinal direction.

Therefore, the cleaning rod 81 (cleaning member 83) can be stably guided with respect to the exposure head 4 by the first guide portion 92a of the second guide member 92. The light emission surface of the lens array 52 of the exposure head 4 can be reliably cleaned by the second guide portion 92b of the second guide member 92.

In addition, positions of the cleaning rod 81 at the time of insertion and at the time of cleaning are restricted by the first guide member 91 and the second guide member 92, and thus it is possible to reliably clean the lens array 52 without separating the cleaning members 83 from the light emission surface of the lens array even when the operator applies an unexpected force.

In addition, by reducing the width (opening) between the first restriction portions 91a and 91a, a space is saved, and the first guide member 91 can be disposed in each color even when the distance between the photoconductive drums 2 of the respective colors is reduced. In addition, it is possible to restrict deflection in the first direction when the operator inserts the cleaning rod 81.

### (Positional Relationship Between Cleaning Member and Exposure Head)

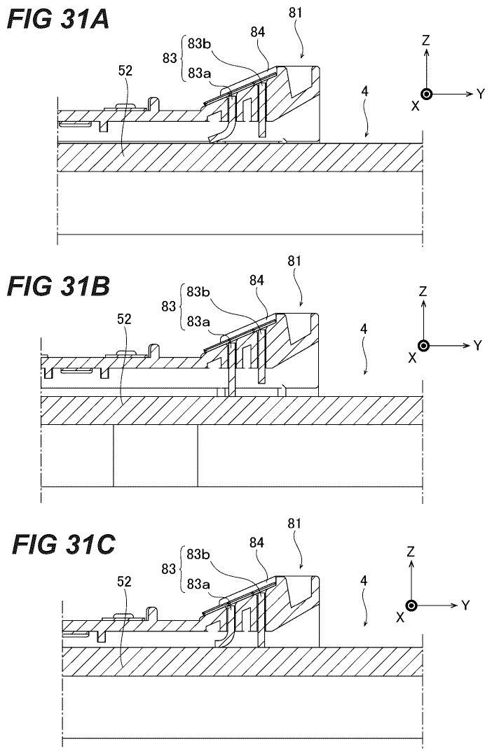

Here, a positional relationship between the two cleaning members 83a and 83b of the cleaning rod 81 and the light emission surface of the exposure head 4 will be described in detail with reference to FIGS. 31A to 31C.

As described above, the two cleaning members 83a and 83b included in the cleaning rod 81 are disposed at different positions in the longitudinal direction of the exposure head 4. Further, the tips of the two cleaning members 83a and 83b are disposed at different positions in the optical axis direction with respect to the light emission surface 52a of the exposure head 4.

At the time of cleaning, the cleaning rod 81 is inserted toward the back side toward the second guide member 92 provided further toward the back side than the first guide member 91 while the position in the second direction is restricted by the second restriction portion 91b and the third restriction portion 91c provided in the first guide member 91. Further, the cleaning rod 81 prevents uplifting of the tip of the cleaning rod 81 by the protruding portion 86 on the tip side that has passed through the first guide member 91 abutting on the second guide portion 92b provided in the second guide member 92. That is, as the cleaning rod 81 is inserted to the back side, the cleaning members 83a and 83b on the tip side are prevented from being separated from the light emission surface of the exposure head 4.

FIG. 31A is a cross-sectional view of the cleaning members 83a and 83b in the vicinity of the tip of the cleaning rod 81 before the protruding portion 86 of the cleaning rod 81 abuts on the second guide portion 92b provided in the second guide member 92. In the cleaning rod 81, the cleaning members 83a and 83b are disposed at different positions in the optical axis direction of the light emission surface of the exposure head 4.

FIG. 31B is a cross-sectional view of the cleaning members 83a and 83b illustrating a state in which the tip of the cleaning rod 81 slightly uplifts. In this case, even if the cleaning member 83b disposed at a position far from the light emission surface of the exposure head 4 is separated from the light emission surface in the optical axis direction, it can be seen that the cleaning member 83a disposed at a position close to the light emission surface can be cleaned without being separated from the light emission surface.

FIG. 31C is a cross-sectional view of the cleaning members 83a and 83b illustrating a state in which the tip of the cleaning rod 81 slightly lifts and lowers. In this case, the side surface of the cleaning member 83a disposed at a position close to the light emission surface of the exposure head 4 in the optical axis direction is in contact with the light emission surface, and an unwiped portion may occur. However, it can be seen that the cleaning member 83b disposed at the position far from the light emission surface of the exposure head 4 can be cleaned by bringing the tip thereof into contact with the light emission surface.

### (Cross-Sectional Shape of Cleaning Rod)

A shape of the notch portion 88 of the cleaning rod 81 will be described with reference to FIGS. 32A and 32B. In other words, cross-sectional shapes of the first portion 81A and the second portion 81B included in the cleaning rod 81 will be described.

FIGS. 32A and 32B are cross-sectional views of the cleaning rod 81 and the exposure head 4 during the cleaning operation, for describing a shape of the notch portion 88. FIG. 32A is a cross-sectional view of the first portion 81A which is a portion other than the notch portion 88 of the cleaning rod 81. FIG. 32B is a cross-sectional view of the second portion 81B which is a portion of the notch portion 88 of the cleaning rod 81.

As illustrated in FIG. 32A, at the time of cleaning, the wall portions 81R and 81L of the cleaning rod 81 are disposed to overlap the casing 54 of the exposure head 4 in the optical axis direction (Z direction) in the first portion 81A which is a portion other than the notch portion 88. As described above, the operator can insert the cleaning rod 81 while restricting a position of the cleaning rod 81 in the first direction (X direction) by using the first restriction portions 91a and 91a provided in the first guide member 91. However, in a case where the operator inserts the cleaning rod 81 while applying a force in the first direction, as the cleaning rod 81 is inserted to the back side, the restriction becomes insufficient only with the first restriction portion 91a. Therefore, by disposing the wall portions 81R and 81L of the cleaning rod 81 and the casing 54 of the exposure head 4 to overlap each other in the optical axis direction, the position of the tip of the cleaning rod 81 in the first direction is restricted, and the cleaning member 83 continues to be in contact with the lens array 52. As a result, the cleaning rod 81 can be inserted to the back side without separating the cleaning member 83 from the light emission surface of the lens array 52, and the light emission surface of the lens array 52 can be reliably cleaned over the entire longitudinal direction.

As illustrated in FIG. 32B, at the time of cleaning, the wall portions 81R and 81L of the cleaning rod 81 are disposed not to overlap the casing 54 of the exposure head 4 in the optical axis direction (Z direction) in the second portion 81B which is a portion of the notch portion 88. With such disposition, as described above, the second portion 81B of the cleaning rod 81 has a smaller geometrical moment of inertia in the optical axis direction (Z direction) and the lateral direction (X direction) than the first portion 81A, and has a shape with a low rigidity.

In other words, the cleaning rod 81 includes the first portion 81A having the first cross-sectional shape illustrated in FIG. 32A and the second portion 81B provided at a position different from the first portion 81A in the Y direction and having the second cross-sectional shape illustrated in FIG. 32B. In the cleaning rod 81, the second cross-sectional shape of the second portion 81B is smaller in area than the first cross-sectional shape of the first portion 81A of the cleaning rod 81.

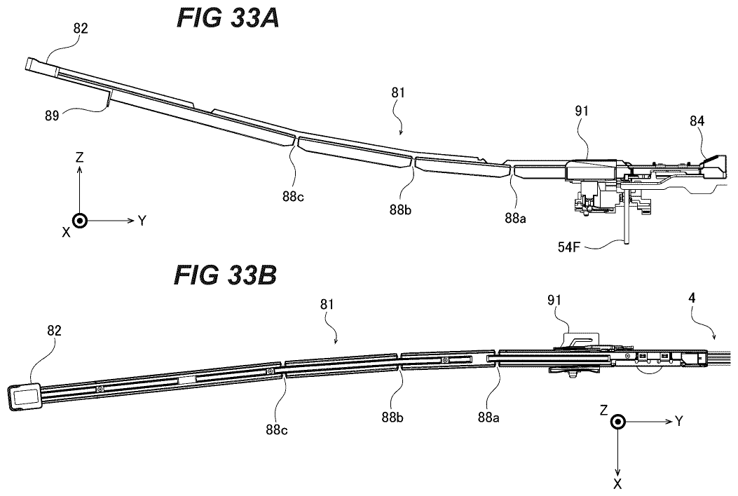

Next, with reference to FIGS. 33A and 33B, a case where the operator applies an unexpected force to the cleaning rod 81 in the middle of the cleaning operation will be described.

FIGS. 33A and 33B are diagrams illustrating a state in which the operator applies an unexpected force to the cleaning rod 81 in the middle of the cleaning operation. FIG. 33A is a side view of the cleaning rod 81 when a force is applied in the optical axis direction (Z direction). FIG. 33B is a top view of the cleaning rod 81 when a force is applied in the lateral direction (X direction).

As described above, in the cleaning rod 81, the second cross-sectional shape of the second portion 81B is smaller in area than the first cross-sectional shape of the first portion 81A of the cleaning rod 81. In other words, since the notch portion 88 is provided, the cleaning rod 81 has a small geometrical moment of inertia in the optical axis direction and the lateral direction and has a shape with a low rigidity.

More specifically, as illustrated in FIGS. 32A and 32B, the cleaning rod 81 has a shape in which the width t6 of the second cross-sectional shape of the second portion 81B in the optical axis direction is smaller than the width t5 of the first cross-sectional shape of the first portion 81A of the cleaning rod 81 in the optical axis direction.

Therefore, in a case where the operator applies an unexpected force to the cleaning rod 81 in the optical axis direction, the cleaning rod 81 has a shape bent in the optical axis direction further toward the front side than the first guide member 91 as illustrated in FIG. 33A. Since the operator performs the work while gripping the grip portion 82, the grip portion 82 is largely displaced in the optical axis direction, and the operator can easily recognize that the unexpected motion is performed. In addition, a stopper may be provided such that an unexpected force is not applied when the cleaning rod 81 which is largely displaced comes into contact with a cover or the like (not illustrated) of the image forming apparatus 100.

As illustrated in FIGS. 32A and 32B, the cleaning rod 81 has a shape in which the width t8 of the second cross-sectional shape of the second portion 81B in the lateral direction is smaller than the width t7 of the first cross-sectional shape of the first portion 81A of the cleaning rod 81 in the lateral direction.

Therefore, in a case where the operator applies an unexpected force to the cleaning rod 81 in the lateral direction, the cleaning rod 81 has a shape bent in the lateral direction further toward the front side than the first guide member 91 as illustrated in FIG. 33B. Since the operator performs the work while gripping the grip portion 82, the grip portion 82 is greatly displaced in the lateral direction, and the operator can easily recognize that the operator is performing an unexpected motion similarly to the case where the cleaning rod 81 is bent in the optical axis direction. In addition, a stopper may be provided such that an unexpected force is not applied when the cleaning rod 81 which is largely displaced comes into contact with a cover or the like (not illustrated) of the image forming apparatus 100.

As described above, even in a case where the operator applies an unexpected force to the cleaning rod 81 at the time of cleaning, the cleaning rod 81 has a shape bent in a direction in which the force is applied further toward the front side than the first guide member 91. Therefore, it is possible to perform reliable cleaning without the tip of the cleaning rod 81 whose position is restricted on the back side of the first guide member 91 or the second guide member 92 being separated from the exposure head 4.

### (Stopper of Cleaning Rod)

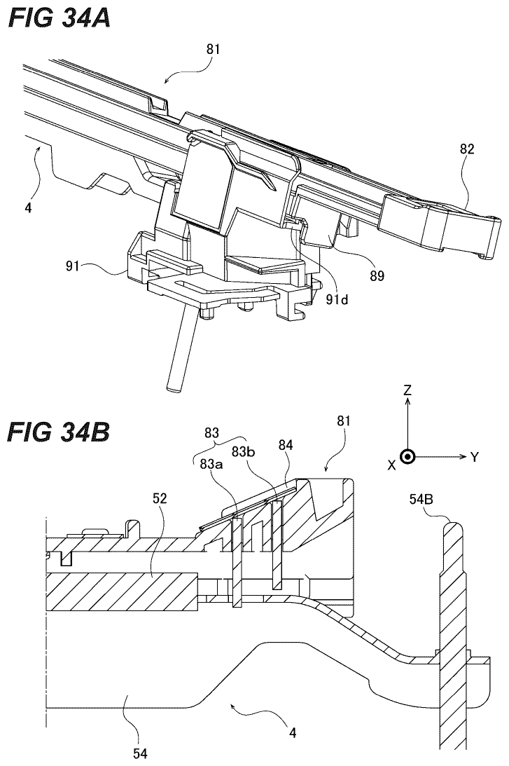

FIGS. 34A and 34B are views illustrating a state in which the cleaning rod 81 is inserted to the back of the main body of the image forming apparatus 100, FIG. 34A is a schematic perspective view of the cleaning rod 81 and the first guide member 91, and FIG. 34B is a cross-sectional view of the tip of the cleaning rod 81 and the exposure head 4.

As illustrated in FIG. 34A, when the operator inserts the cleaning rod 81 to the back side of the image forming apparatus 100, the wall 89 of the cleaning rod 81 and the abutment portion 91d of the first guide member 91 abut on each other, the position of the cleaning rod 81 is restricted, and the cleaning rod cannot be inserted to the back side any more. In this case, as illustrated in FIG. 34B, both the cleaning member 83a and the cleaning member 83b are beyond the end of the lens array 52 on the back side. That is, the wall 89 (or the abutment portion of the first guide member 91) of the cleaning rod 81 is disposed such that the position is restricted by the first guide member 91 at a position where the cleaning members 83a and 83b at the tips thereof are beyond the end of the lens array 52 on the back side. With such disposition, attached matter removed from the lens array 52 by the cleaning member 83 can be moved to the outside of the lens array 52.

### (Dimensional Relationship Between Cleaning Rod and First Guide Member)

Next, a dimensional relationship of each portion of the cleaning rod 81 and the first guide member 91 will be described in detail with reference to FIGS. 35A and 35B.

FIGS. 35A and 35B are views illustrating a dimensional relationship of each portion of the cleaning rod 81 and the first guide member 91, in which FIG. 35A is a side view in the state of FIG. 34A, and FIG. 35B is a top view of the first guide member 91.

As illustrated in FIG. 35A, the cleaning rod 81 has notch portions 88 (88a, 88b, 88c) at a plurality of locations in the longitudinal direction (Y direction). In other words, the cleaning rod 81 has a plurality of second portions 81B in the longitudinal direction (Y direction). Here, an interval between the notch portion 88a and the notch portion 88b and an interval between the notch portion 88b and the notch portion 88c in the longitudinal direction of the cleaning rod 81 are Lp, and an interval between the wall 89 of the cleaning rod 81 and the notch portion 88c closest to the wall 89 is Lr.

As illustrated in FIG. 35B, a length of the first restriction portion 91a in the longitudinal direction (Y direction) of the first guide member 91 is defined as a longitudinal direction guide length Ly, and a length from the second restriction portion 91b to the third restriction portion 91c is defined as an optical axis direction guide length Lz.

In this case, the following dimensional relationship (1) is established between the cleaning rod 81 and the first guide member 91.

$$Lp > Ly and Lp > Lz \qquad ( 1 )$$

In the present embodiment, the interval between the notch portions adjacent in the longitudinal direction in the cleaning rod 81 is Lp, but an interval between any two notch portions may be longer than the guide length of the first guide member 91, and for example, the following dimensional relationship (2) may be established for an interval Lp′ between the notch portion 88a and the notch portion 88c.

$$Lp ’ > Ly and Lp ’ > Lz \qquad ( 2 )$$

The first guide member 91 is a rigid body, and the guide length Ly which is a region engaged with the cleaning rod 81, is in a substantially rigid body state in a state of guiding the cleaning rod 81. That is, when all the notch portions 88 of the cleaning rod 81 are included in the guide length Ly which is the region engaged with the cleaning rod 81 of the first guide member 91, the cleaning rod 81 cannot be deformed by the notch portions 88. As a result, when the operator applies an unexpected force to the cleaning rod 81, the displacement amount of the cleaning rod 81 decreases, and the effect of causing the operator to recognize that the unexpected force is applied as described above cannot be obtained. Therefore, the notch portions 88 adjacent to each other in the longitudinal direction are disposed apart from each other such that the interval Lp between at least two sets of notch portions 88 is larger than the guide length Ly and the guide length Lz of the first guide member 91 in the longitudinal direction. That is, the notch portions 88 adjacent to each other in the longitudinal direction are disposed apart from each other so that the dimensional relationship (1) is established.

The guide length Ly and the guide length Lz of the first guide member 91 satisfy the following dimensional relationship (3).

$$Lr > Lz \qquad ( 3 )$$

There is a minute gap between the first guide member 91 and the cleaning rod 81, and the cleaning rod 81 can be displaced by the gap. The wall 89 provided in the cleaning rod 81 is disposed to extend in the optical axis direction, and abuts on the first guide member 91 to restrict the position of the cleaning rod 81. However, when the notch portion 88 is disposed in the vicinity of the wall 89, the cleaning rod 81 becomes deformable in a minute gap in the first guide member 91, and the wall 89 and the abutment portion 91d of the first guide member 91 do not abut. As a result, there is a possibility that the cleaning rod 81 is not restricted by the first guide member 91 and is inserted deeper than a predetermined position in the image forming apparatus 100. Therefore, an interval Lr between the wall 89 of the cleaning rod 81 and the notch portion 88 is larger than the guide portion length Lz of the first guide member 91. In the present embodiment, since the wall 89 provided in the cleaning rod 81 extends in the optical axis direction and abuts on the first guide member 91, the relationship between the interval Lr and the optical axis direction guide length Lz needs to satisfy the dimensional relationship (3).

However, the present invention is not limited to this relationship, and for example, when the wall 89 provided in the cleaning rod 81 is disposed to extend in the lateral direction, a relationship between the interval Lr and the lateral direction guide length Ly may satisfy the following dimensional relationship (4).

$$Lr > Ly \qquad ( 4 )$$

Therefore, the interval Lr between the wall 89 of the cleaning rod 81 and the notch portion 88c is larger than the length Ly or Lz of the guide portion of the first guide member 91.

With the above configuration, when the operator inserts the cleaning rod 81 into the image forming apparatus 100, even if the operator performs the work while applying an unexpected force, the cleaning rod 81 is stably inserted, and the exposure head 4 can be stably and reliably cleaned.

### Other Embodiments

In the above-described embodiment, the four-color full-color printer of the tandem system-intermediate transfer system has been described as an example, but for example, a direct transfer system in which a toner image is transferred from the photoconductive drum 2 to the recording sheet P without using the intermediate transfer belt 9 may be used. Furthermore, a full color printer of five or more colors using a single color mono-color toner or a spot color toner may be used. In that case, a configuration including the exposure heads 4 corresponding to the number of colors may be used.

In addition, the up-down direction of the units and components has been described according to the disposition of the units in the cross-sectional view of the image forming apparatus 100 illustrated in FIG. 1. However, a unit disposition in which the photoconductive drum 2 is disposed above the intermediate transfer belt 9 and the exposure head 4 is further disposed above the photoconductive drum 2 as in an upper surface exposure system in which the photoconductive drum 2 is exposed from substantially above may be adopted. In that case, the upper and lower sides in the description of the embodiment are all reversed.

In addition, in the above-described embodiment, as the holding member that holds the substrate and the lens array, the casing 54 made of an electrogalvanized steel plate manufactured through press working and having a pilot hole has been exemplified, but a material or a manufacturing method of the holding member are not limited thereto. The casing 54 may have at least one hole that forms a minute gap at the boundary with the abutted sealing auxiliary member 74, and a stainless steel plate using press working, a resin material such as LCP using molding, an aluminum material using die casting, or the like may be selected according to the performance required for the exposure head 4. In a case where the casing (holding member) is manufactured through molding or die casting, there is an advantage that the degree of freedom in design regarding a shape and disposition of the above-described holes is increased compared with a case where a sheet metal is pressed.

Similarly, a material of the sealing auxiliary member 74 is not limited to the configuration described in the above-described embodiment. The sealing auxiliary member 74 may be made of a metal such as aluminum or may be made of a resin material such as LCP different from that in the embodiment as long as the sealing auxiliary member can abut on and cover the periphery of the hole provided in the casing 54. If the sealing auxiliary member 74 is made of a metal, there is an advantage that a heat dissipation property is excellent since thermal conductivity is high. Furthermore, in a case where the hole provided in the casing 54 is small, or in a case where the adhesive 58 has a high viscosity, it is not necessary to use the sealing auxiliary member 74, and the hole of the casing 54 may be sealed using only the adhesive 58.

Further, in the above-described embodiment, the pilot hole generated for the convenience of manufacturing the casing 54 is utilized, but a hole shape may be intentionally provided in the casing 54 separately from the pilot hole. For example, if a hole can be provided for the purpose of forming a gap on the casing side surface on the drum unit side farther away from the photoconductive drum 2 and the development unit 24, the possibility that toner enters the sealed space of the exposure head 4 can be reduced.

Further, in the above-described embodiment, the pilot hole generated for the convenience of manufacturing the casing 54 is utilized as the hole provided in the casing 54, but the purpose of providing the hole in the casing 54, a shape of the hole, and a position of the hole are not limited to the configuration described in the above-described embodiment. For example, a hole may be intentionally provided in the casing 54 separately from the pilot hole, such as a hole for cleaning the inside at the end of manufacturing of the exposure head, a hole for use in fixing to a manufacturing apparatus, or a hole for applying UV light for curing an adhesive. Alternatively, a hole may be provided for the purpose of forming a gap on the casing side surface on the drum unit side separated from the photoconductive drum 2 and the development unit 24. According to this configuration, the possibility that toner enters the sealed space of the exposure head 4 can be reduced. A shape of the hole is not limited to a round shape, and a position of the hole is not limited to the upper surface (reference surface) of the casing 54. For example, a square hole may be provided on the side surface (substrate support portion) of the casing 54 in order to fix the substrate 50 to the casing 54.

In addition, as for the sealant 59 and the adhesive 58, separate ones may be used as in the above-described embodiment, similar ones may be used, and a plurality of types may be used properly. For example, acrylic, silicon, epoxy, or the like may be selected as a material, and the curing type may be selected as appropriate depending on the performance of the exposure head 4 or the convenience of manufacturing, such as photocurability, thermosetting, moisture curability, or anaerobic curability.

In the above-described embodiment, the configuration in which the sealing member 71 is the sheet member 72 has been exemplified, but the present invention is not limited thereto, and the sealing member 71 may be a filler (sealant). The gap t1 between the casing support member 55 and the casing 54 (see FIG. 18A) may be sealed by filling the gap t1 with a moisture-curable silicone resin as a filler. In addition, a filler (sealant) is not limited to a moisture-curable resin, and may be, for example, a photocurable adhesive, a foamed sealing material made of a sponge material, or the like.

In the above-described embodiment, the configuration has been exemplified in which the duct formed between the casing support member 55 and the casing 54 is separated into the duct portion and the non-duct portion by providing the protrusion 55b, and the gap therebetween is sealed by the elastic member 73, but the present invention is not limited thereto. For example, a duct formed between the casing support member 55 and the casing 54 may be separated into a duct portion and a non-duct portion by providing a protrusion 55b, and a gap between the duct portion and the non-duct portion may be sealed with a sealant. Alternatively, a sealant may be provided to separate the duct formed between the casing support member 55 and the casing 54 into the duct portion and the non-duct portion, and the gap between the duct portion and the non-duct portion may be sealed by the sealant. The sealant may be a moisture-curable silicone resin similar to the sealant 59 that seals the gap between the casing 54 and the lens array 52 and the gap between the casing 54 and the substrate 50. Alternatively, the sealant is not limited to a moisture-curable resin, and may be, for example, a photocurable adhesive or a foamable sealing material.

According to the present invention, it is possible to reliably clean off attached matter attached to the emission surface of the lens by the cleaning member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-088846, filed May 31, 2024, which is hereby incorporated by reference herein in its entirety.

What is claimed is:

1. An image forming apparatus comprising:
a photoconductor;
an exposure head that includes a substrate on which a plurality of light emitting elements is mounted in a longitudinal direction that is an axial direction of the photoconductor, and a lens array including a plurality of lenses that condenses light emitted from the light emitting elements onto the photoconductor, and exposes the photoconductor;
a longitudinal-shaped cleaning rod that is inserted from outside of the image forming apparatus and cleans emission surfaces of the lenses by rubbing the lenses in the longitudinal direction; and
a guide member that guides the cleaning rod inserted from the outside of the image forming apparatus, wherein
the cleaning rod includes
a cleaning member that abuts on the emission surfaces of the lenses and cleans off attached matter attached to the emission surfaces of the lenses,
a first portion whose cross-sectional shape in a direction orthogonal to the longitudinal direction is a first cross-sectional shape, and
a second portion that is provided at a position different from a position of the first portion in the longitudinal direction and has a second cross-sectional shape different from the first cross-sectional shape of the first portion.

2. The image forming apparatus according to claim 1, wherein
the second cross-sectional shape is smaller in area than the first cross-sectional shape.

3. The image forming apparatus according to claim 1, wherein
the second cross-sectional shape has a width smaller than a width of the first cross-sectional shape in an optical axis direction along an optical axis of the lenses.

4. The image forming apparatus according to claim 1, wherein
the second cross-sectional shape has a width smaller than a width of the first cross-sectional shape in a lateral direction orthogonal to the longitudinal direction of the substrate.

5. The image forming apparatus according to claim 1, wherein
the second portion has a geometrical moment of inertia smaller than a geometrical moment of inertia of the first portion.

6. The image forming apparatus according to claim 1, wherein
the cleaning rod has a plurality of the second portions.

7. The image forming apparatus according to claim 1, wherein
the guide member has a length in the longitudinal direction, and
the first portion of the cleaning rod is longer than the guide member in the longitudinal direction.

8. The image forming apparatus according to claim 1, wherein
the cleaning rod has a wall portion that is engaged with the exposure head over the longitudinal direction.

9. The image forming apparatus according to claim 8, wherein
the wall portion is shorter in the second portion than in the first portion.

10. The image forming apparatus according to claim 1, wherein
the cleaning rod has a cross-sectional shape including
a facing portion that faces the emission surfaces of the lenses and supports the cleaning member, and
a wall portion that extends from both sides of the facing portion in a lateral direction orthogonal to the longitudinal direction to the exposure head side and is engaged with the exposure head,
the first portion has the first cross-sectional shape including the facing portion and the wall portion, and
the second portion has the second cross-sectional shape including at least the facing portion.

11. The image forming apparatus according to claim 1, wherein the light emitting elements are organic EL elements.
